(19) United States
(12) Patent Application Publication
(10) Pub. No.: US 2011/0177214 A1
(43) Pub. Date: Jul. 21, 2011

(54) LOW PRESSURE DOUGH PACKAGING

(76) Inventors: David J. Domingues, Plymouth, MN (US); Richard Freeman, Saffron Walden (GB); Joanne J. Garbe, Columbia Heigths, MN (US); Claire Thurbush, Minneapolis, MN (US); Scott Kackman, New Hope, MN (US); David A. Kirk, Coon Rapids, MN (US); Todd Purkey, Apple Valley, MN (US); Kay Sinclair, Newmarket (GB); Gary Stacey, Cambridge (GB); Matthew C. White, Shepreth (GB)

(21) Appl. No.: 13/076,523

(22) Filed: Mar. 31, 2011

Related U.S. Application Data
(63) Continuation of application No. 12/118,983, filed on May 12, 2008.
(60) Provisional application No. 60/928,706, filed on May 11, 2007.

(51) Int. Cl. A21D 10/02

(52) U.S. Cl. 426/128; 426/415; 426/412

(57) ABSTRACT

Described are dough packages that include one or more of a container and an opening, optionally including an open end and an endcap, wherein the package may be vented or non-vented, and may contain dough for storage at refrigerated conditions.

### CROSS-REFERENCE TO RELATED APPLICATIONS

This application claims the benefit of priority under 35 U.S.C. 119(e)(1) of a provisional patent application, Ser. No. 60/928,706, filed May 11, 2007, which is incorporated herein by reference in its entirety.

### FIELD OF THE INVENTION

The invention described herein relates to various features of packaging materials and design useful for refrigerated dough products. The dough product contained in the package can be any of a wide variety of leavenable dough products that can be used by a consumer to “home bake” a dough to produce a desirable hot, fresh-baked item. Many such items are proofed prior to baking, and for consumer convenience may be partially or fully proofed prior to purchase and prior to use by the end consumer. Such products, sold after proofing or partial proofing, are examples of products referred to as “pre-proofed.” Examples of pre-proofed dough products include breads and bread-like products that generally contain a leavening ingredient and include but are not limited to loaves of bread such as French bread, white or whole wheat bread, bread sticks, biscuits (i.e., “soda biscuits”), rolls, pizza dough, and the like.

### BACKGROUND OF THE INVENTION

One technique for preparing a pre-proofed dough product for sale is by use of a package having a fixed volume and venting, and allowing a contained dough composition to proof and expand inside of the packaging and seal the container from inside, e.g., self-sealing packages such as wound paperboard or paperboard canisters. Such products include dough formulations that can be, but are not necessarily, chemically-leavenable.

For example, one method of accommodating proofing of a chemically-leavenable dough composition during or prior to refrigerated storage is to place an unproofed dough composition in a fixed volume package. The dough is allowed to proof or partially proof inside of the package. With expansion of the dough composition, the dough volume increases to fill the entire package volume, and upon further expansion will increase the pressure inside the canister (if desired). The package can be, for example, a wound canister formed from composite paperboard and spirally wound into a cylinder. The initial volume of dough packed into the canister can be less than or equal to the canister volume and as the dough proofs, gas is expelled through venting. Once the dough reaches the approximate volume of the canister, the pressure increases to force the dough against canister end caps to seal gas passages around the end caps of the canister.

There is continuing need for new types of packaged pre-proofed dough products that may be refrigerator stable for multiple weeks of refrigerated storage. Similarly, there is continuing need for new methods of packaging and preparing such packaged dough products. Particularly useful and economical packages are those that are simple and durable, such as flexible film packaging with no pressure release valve.

The invention relates to dough packages that include various designs and constructions for allowing a dough to expand and proof or pre-proof within a package suitable for refrigerated storage. The package may be of a fixed volume or a variable volume and may include creative design features to allow gas to be expelled from the package. The packages generally may be in the form of any of a chub, cylinder (e.g., can or canister), pouch, etc., and any of the inventive packages can be pressurized (e.g., of an internal pressure of 15 psig or greater) or non-pressurized (of an internal pressure of less than 15 psig) upon expansion of the dough inside of the container. (Packages as described herein are can be particularly useful with non-pressurized dough container configurations.) An elongate package may be a cylinder, or other shape tube (e.g., square, rectangular, triangular), with two endcaps, one at each end. The endcaps may be removable or otherwise openable to allow the package to be opened, or, the package may be opened by disassembling the tube, such as by unwinding a wound tube.

Packages of the invention are dough product packages that may include materials that are flexible, rigid, or semi-rigid, for ends or sides of a package. Gases such as carbon dioxide, oxygen, or an inert gas (e.g., from flushing) may be present at the package interior due to packaging and processing history or due to proofing of the packaged dough composition and attendant production of carbon dioxide by a dough leavening system. A dough may also produce carbon dioxide and experience expansion within the package by proofing or partial proofing after being inserted into the package. Any gas that is present in the interior space of the package during dough expansion is desirably expelled from the package as the dough expands into the internal volume of the package. Various modes are described for allowing gas to be expelled from a package.

The package sides and ends can be of flexible, rigid, or semi-rigid packaging material, or a combination of these, and may include material impermeable to gases such as oxygen, carbon dioxide, water vapor, etc. Exemplary flexible materials include flexible polymeric films including those that are presently known or that may be developed in the future for use in packaging dough compositions. Exemplary rigid or semi-rigid materials include paperboard, plastic, and the like. For example, sides of a package may be in the form of a rigid or semi-rigid cylindrical can or canister, with end caps. The can or cylinder may be made of any desirable material such as paper, paperboard, plastic or another polymeric material. End caps may also be made of any useful material such as paperboard, paper, foil, metal, metal coated paper, plastic, or another polymeric material.

The dough composition can be any type of leavenable dough composition, e.g., a proofed or unproofed dough composition that is storage-stable at refrigerated storage temperature. The dough composition can be leavenable by action of yeast or chemical leavening agents. Examples of useful types of dough compositions include chemically-leavenable biscuits (“soda” biscuits), breads, and bread-like dough compositions including French bread, bread rolls, croissants, sweet rolls, pizza crust.

### SUMMARY OF THE INVENTION

Certain embodiments of the invention include a pre-proofed dough composition packaged in a low pressure flexible package, optionally and preferably with little or no headspace. A low pressure package can mean a package that is substantially air tight, with an internal pressure that is typically less than 15 psig (pounds per square inch, gauge) (gauge pressure is absolute pressure minus atmospheric pressure, i.e., psig is psi absolute minus approximately 1 atmosphere or 14.7 psi; for example a gauge pressure of 0 psig inside a package is a pressure of approximately 1 atmosphere). Examples of low pressure packages include canisters, chubs, and pouches that do not exhibit a pressurized (greater than 15 psig) interior. A dislike of some consumers with the use of certain current pressurized refrigerator-stable dough products is that pressurized packages can pop when opened. Advantageously, embodiments of packages described herein, which include a non-pressurized packaging system, can avoid this popping, because the internal pressure does not build to the same levels of the current consumer products that do pop when opened.

Methods of the invention can involve placing unproofed dough into a package that that is designed to allow the dough to expand while proofing or partially proofing inside of the package. The package may optionally be flushed with carbon dioxide, or an inert gas such as nitrogen, during a step of placing the dough into a package. The dough, within the package, can increase in size by expansion due to a leavening agent, to take up interior space of the package. The package can be either of a fixed volume or a variable volume. A fixed volume package may include venting that allows gases inside of the package to be expelled. In other embodiments, a variable-volume package may expand to increase in volume as the dough inside of the package also expands. With either a fixed or a variable volume package, the dough can expand and the final pressure of the dough can depend on the amount of expansion of the dough relative to the fixed or expanded volume of the package. A package, upon expansion of the dough, may be pressurized (e.g., have an internal pressure of 15 psig or more) or may be non-pressurized (e.g., have an ambient internal pressure (0 psig, 1 atm) or a pressure in the range from 0 psig to 10 psig, e.g., from 3 psig to 8 psig).

In certain embodiments the package containing the expanded dough can include limited headspace, preferably very little or no headspace. “Headspace” refers to the internal volume within a package that is not taken up by dough composition; i.e., the internal volume as packaged not including the dough product. The headspace of a packaged dough composition described herein can be, e.g., less than about 20 percent (dough cans) of the total internal volume of the packaged product, such as, less than 3 percent of the total internal package volume.

Exemplary packaged dough products of the invention can be designed to produce a packaged product of a dough with a desired raw specific volume as measured inside the package (e.g., from 1.2 to 2.0 cc/gram), and a package having an internal pressure within a desired range (e.g., 0 to 15 psig).

The invention allows a dough composition to expand, e.g., proof or partially proof, inside of a package. This advantageously reduces steps of handling the dough composition that would otherwise be required if the dough composition were first proofed or partially proofed outside of the package, and then placed into a package in an expanded condition. Additionally, proofing or partially proofing after packaging may reduce or eliminate potential contamination of a dough product.

In different embodiments, a dough may be packaged and stored at refrigerated or frozen conditions, proofed or unproofed. A dough may for example be packaged in an unproofed condition and refrigerated, with the dough proofing during refrigerated storage following packaging. Alternately, a dough may be packaged in an unproofed condition, then frozen before being proofed; the dough may be stored and optionally shipped and sold in the unproofed frozen state, then thawed, after which the dough can proof within the package.

As used in the present description, “proof” and “proofing” relate to a step before baking of a dough composition that allows at least partial expansion (i.e., at least partial proofing) of a dough composition by giving time to allow yeast or chemical leavening agents to produce leavening gas that forms bubbles within the dough composition and thereby expands the dough composition to a desired volume.

“Pre-proofed” means that a dough product does not require a proofing step after removal from refrigerated or frozen storage, prior to cooking, e.g., baking.

The term “unproofed” is used as generally understood in the dough and baking arts, e.g., to refer to a dough composition that has not been processed to include timing intended to cause or allow proofing or intentional leavening of a dough composition. For example, a dough composition may not have been subjected to a specific holding stage for causing the volume of the dough to increase by 10% or more.

### BRIEF DESCRIPTION OF THE DRAWINGS

FIG. 1 illustrates various methods of accommodating gas release in dough packaging configurations, e.g., gas releases from a dough contained in the package and the package accommodated the release by expelling the gas from the container, by expansion of the container, etc.

FIGS. 2, 3, and 4 illustrate and describe certain examples of direct methods and package features for accommodating gas release.

FIGS. 5, 6, 7, 8 illustrate and describe examples of direct/expanding methods of accommodating gas release, and related product features.

FIGS. 9, 10, 11, 12, and 13 illustrate and describe examples of expanding methods of accommodating gas release and related product features.

FIGS. 14 and 15 illustrate and describe examples of methods of accommodating gas release that involve vacuum, and related product features.

FIG. 16 describes an example of a method of accommodating gas release that involves osmotic permeability, and related product features.

FIG. 17 describes an example of a method of accommodating gas release that involves a low pressure package, and related product features.

FIGS. 18 and 19 illustrate and describe examples of method of accommodating gas release that involve an openable endcap, and related product features.

FIG. 20 illustrates and describes an example of a package sealed using a ring or ring clip.

FIG. 21 illustrates and describes an example of an end portion of a cylindrical can.

FIG. 22 illustrates and describes an example of a vented package.

FIG. 23 illustrates and describes an example of an expandable package, e.g., variable-volume cylindrical package.

FIG. 24 illustrates and describes a package that includes shrinkwrap.

FIG. 25 illustrates and describes a package that includes an external securing mechanism.

FIG. 26 illustrates and describes a package that includes an endcap.

FIG. 27 illustrates and describes a package that includes an endcap.

FIG. 28 illustrates and describes a package that features a wound can or canister.

FIG. 29 illustrates and describes a package that features a wound can or canister.

FIG. 30 illustrates and describes a package that features a vent.

FIG. 31 illustrates and describes a package that features an endcap.

FIG. 32 illustrates and describes a package that features a wound can or canister.

FIG. 33 illustrates and describes a package that features a garotte.

FIG. 34 illustrates and describes a package that features a threaded endcap.

FIGS. 35 through 48 illustrate and describe packages that feature an endcap.

FIG. 49 illustrates and describes a package that features a vented end.

FIG. 50 illustrates and describes a package that features expanding parts.

### DETAILED DESCRIPTION OF THE PREFERRED EMBODIMENTS

The invention may be more completely understood in consideration of the following detailed description of various embodiments of the invention in connection with the accompanying drawings, in which:

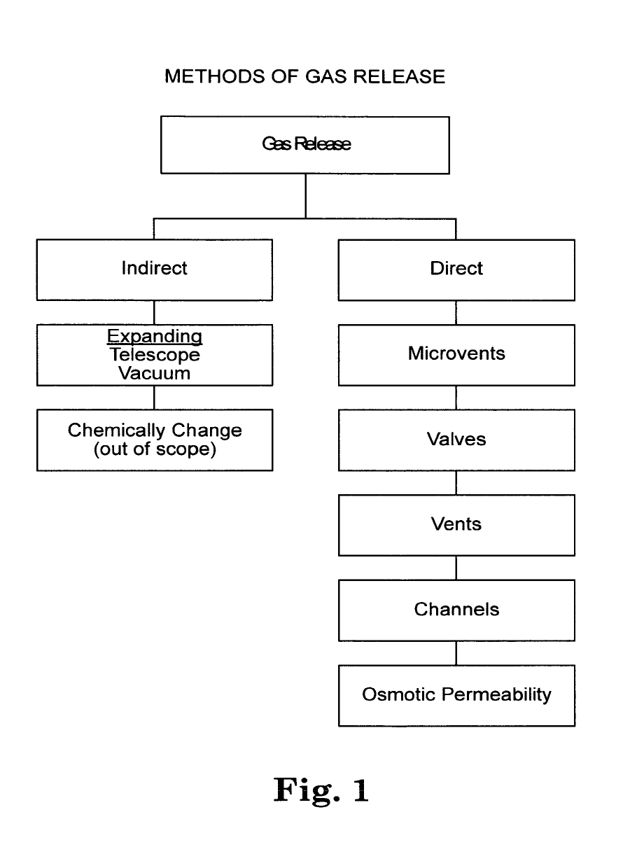

Referring now to FIG. 1, this shows a chart of different methods of releasing gas from a dough composition or a container that includes a dough composition, to allow proofing of the dough composition after the dough has been placed into a package. One general method of allowing gas release and expansion of the dough is referred to as “indirect” gas release, which allows the package of the product to contain an expanding dough product, either by expanding along with the dough or by including space into which the dough can expand. Indirect methods can be accomplished by a dough package that can expand or telescope, or that has been evacuated (see left side “Expanding, Telescoping, Vacuum”). Another a general type of method is the “direct” method, by which gas is vented from the interior of the package to an exterior through channels, vents, valves, or by osmotic permeability.

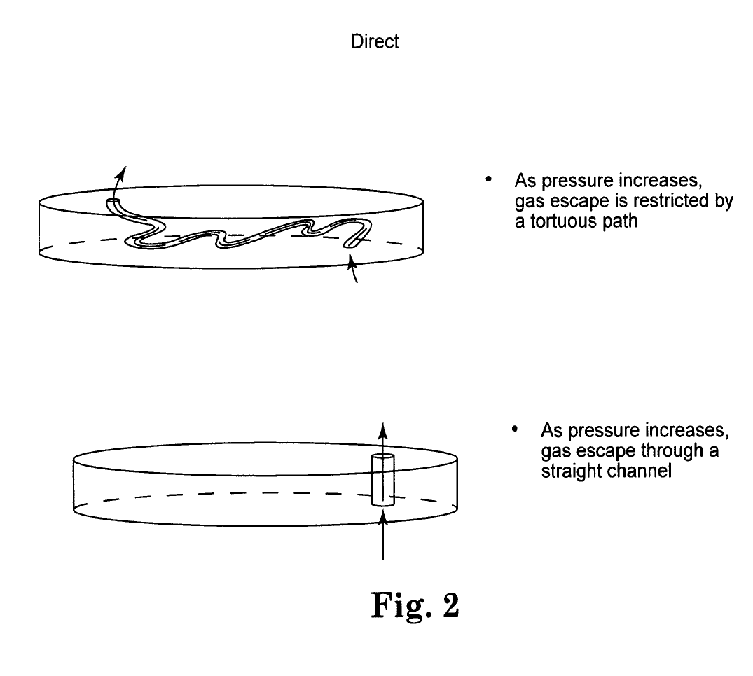

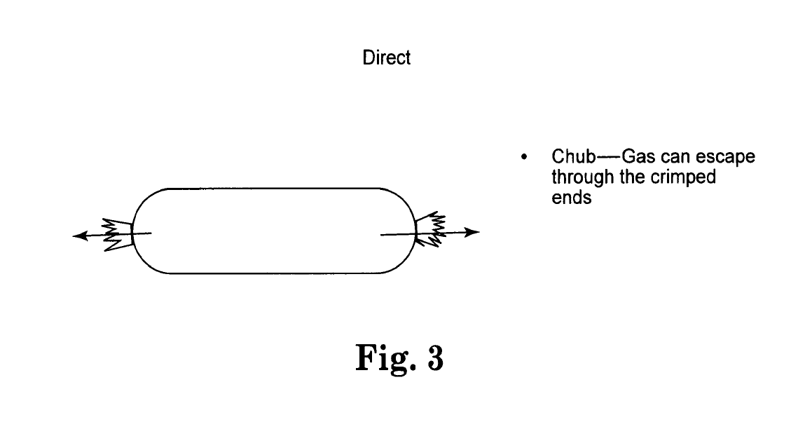

FIG. 2 shows two types of direct venting methods. A first is venting of gas through a tortuous path. A second is venting gas through a straight channel. Either can be used with any packaging configuration such as a plastic or paperboard canister, pouch, or chub. The tortuous path or straight vents may be located, for example, at a side wall of a chub, canister, or pouch, at an end-cap of a canister or can, at a seam of a pouch, or at a cinched or crimped, closed end of a chub (see FIG. 3).

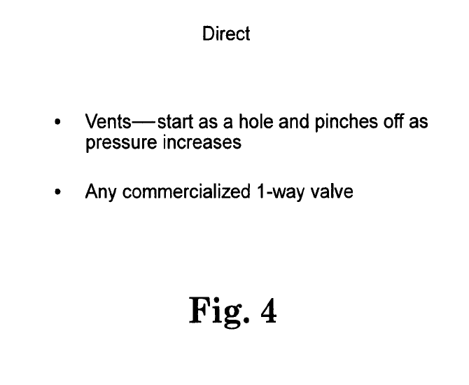

FIG. 4 describes that vents can be various in design, such as micro-vents, cinched apertures, boundaries between thermo-sealed pieces of a package, boundaries between a canister body and an end cap, valves, etc. A vent can be a one-way valve, which is sealed in one direction.

A vent may become sealed by any method, such as by dough that expands within the package to contact and close a vent, or by a mechanical closure that is actuated by expanding dough or by gas released from the dough. Specifically, a dough composition inside of a package that contains vents can expand to contact, cover, or fill the vent in a manner that will close the vent and prevent further gas from passing through the vent in either direction. Alternately, a vent may be located next to a mechanical structure or closure that is actuated upon expansion of dough or release of gas by the dough; the mechanical structure may be a hinged gate or a moveable sheet, or the like, that is moved by expanding dough to cover a vent from the inside of the package, to cover and seal the vent and prevent further venting.

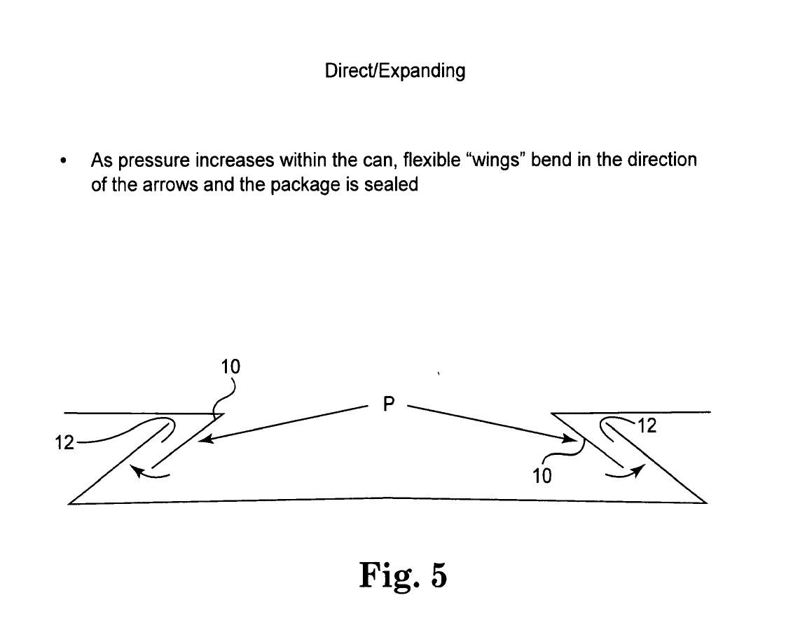

FIG. 5 illustrates a specific example of a mechanical structure that can be moved by dough that expands within an interior of a dough package. The dough expands to come into direct contact with “wings” 10 and the pressure of the expanding dough causes wings 10 to move in a manner that closes opening or vent 12.

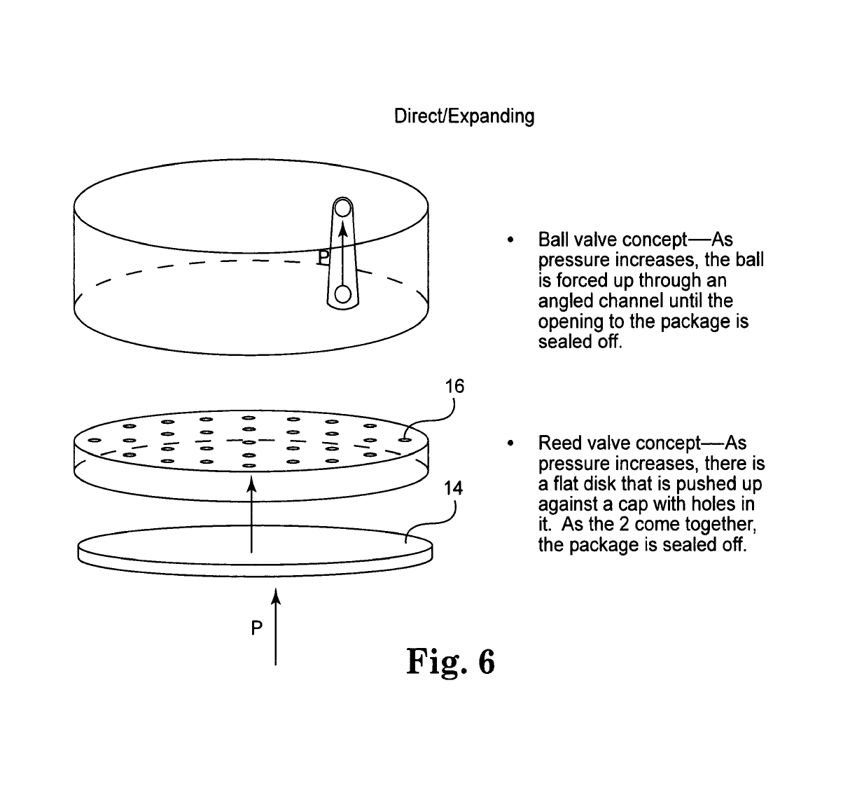

FIG. 6 illustrates two examples of a mechanical structure that can be moved by expanding dough to be closed from the inside of the package. The top drawing of FIG. 6 shows a ball valve that can be in the form of a ball contained in a channel, the channel optionally including a closing or tapering diameter so that the movement of the ball causes the channel to be closed. The ball can be moved by dough that expands to contact the ball and move the ball through the channel to a position that closes the channel. The lower drawing shows a sheet or flat disk 14 of material located between a dough composition (not shown) on one side and holes, vents, or channels 16 of a package surface on the other side. As the dough expands within the package the sheet or disk 14 moves into contact with the portion of the package that contains holes, vents, or channels 16, and the disk 14 covers the holes, vents, or channels, 16 to prevent further venting.

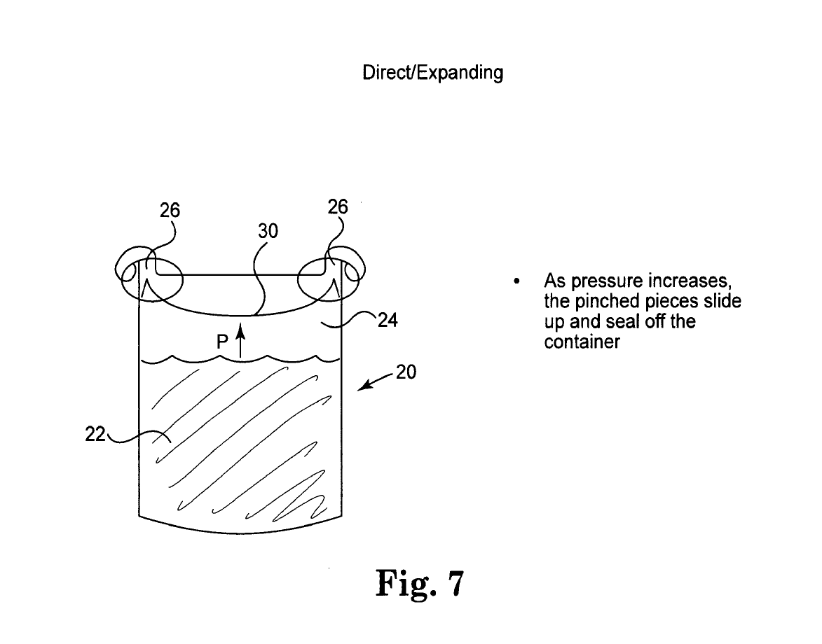

FIG. 7 illustrates another example of a mechanical structure that can be moved by expanding dough to cause the package to be sealed from the inside of the package. Packaged dough product 20 includes dough 22, headspace 24 and open channels 26 through which gas can escape while dough 22 expands. Mechanical closure 30 allows gas to escape through vents 26, until dough 22 contacts closure 30, and closure 30 moves to cover or close gaps 26, after which further venting is prevented.

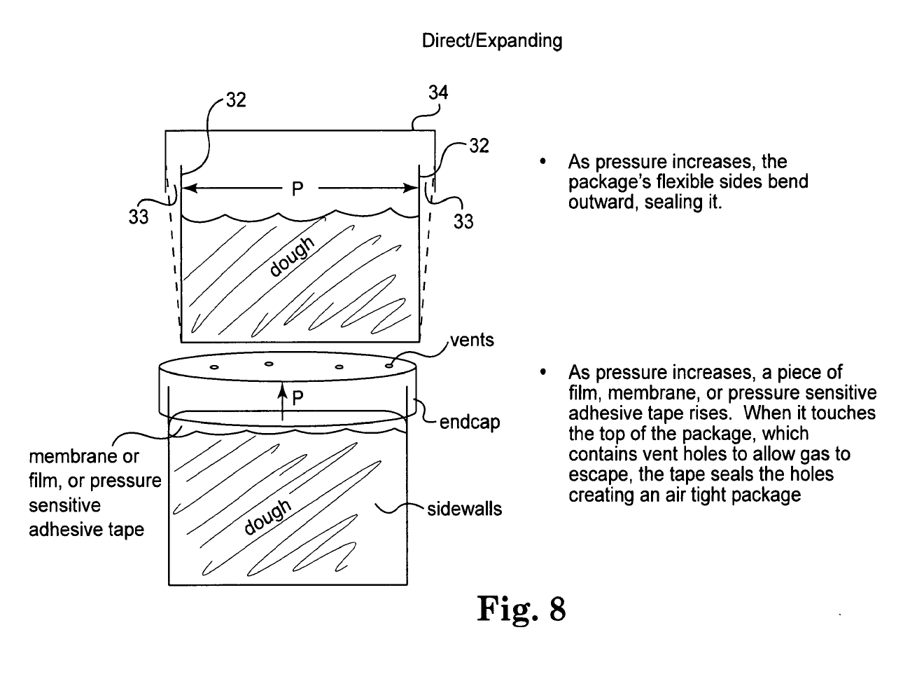

FIG. 8 illustrates two examples of a mechanical structure that can be moved by expanding dough to be closed from the inside of the package. The top drawing shows a package that includes sidewalls 32 and endcap 34, with gap (vent) 33 between the two allowing venting. As dough inside of the container expands, gas escapes through gaps (vents) 33 until pressure from the expanding dough causes sidewalls 32 to contact the lip of endcap 34, sealing gap 33 and preventing further venting. Sidewalls 32 can be biased to remain open until a desired pressure occurs within the package to close gaps 33. Not shown at the top illustration of FIG. 8, but optionally included in this and similar packaging designs, is the optional use of a caulk, sealant, or other material to improve the seal between the lip of endcap 34 and sidewalls 33. For example, an elastomeric, optionally adhesive, bead may be placed between these two surfaces so that when the surfaces contact, an air-tight seal results.

The lower picture at FIG. 8 shows a similar package configuration except that vents are in the form of apertures in the endcap, and the mechanical structure that closes the vents in the endcap is a membrane or film that is in contact with the dough composition. The film may optionally include an adhesive (e.g., pressure sensitive adhesive) on the side that will contact the endcap. The dough will expand to cause a venting of gas from the headspace of the container until the membrane contacts the endcap to cover the vents, after which no additional venting will occur.

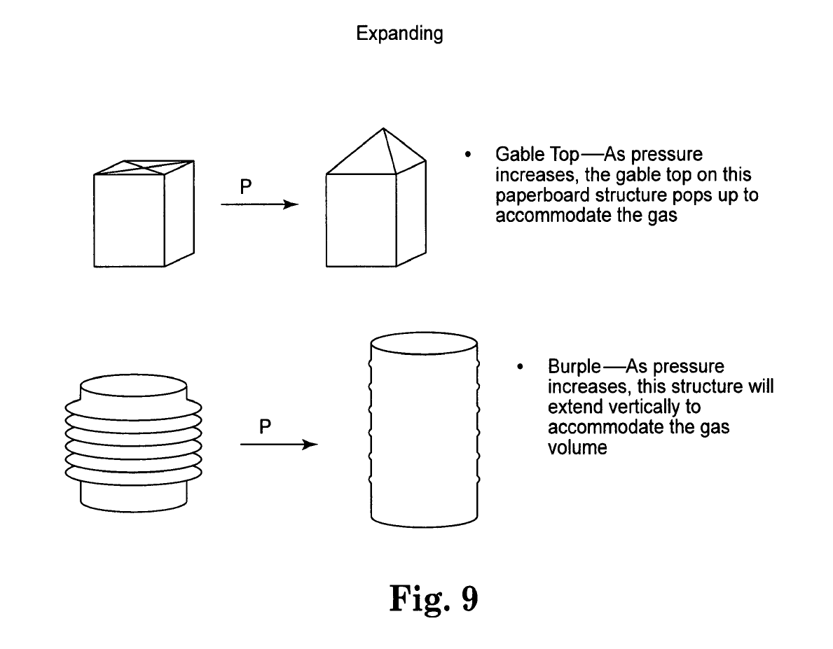

FIG. 9 shows two exemplary forms of expanding volume packages. In general, containers that have a variable, increasing volume, can be non-vented and can become pressurized or can be at ambient pressure upon expansion of a dough within the container. The package can be used to contain an unproofed dough composition with little or no headspace. The geometry of the package or the use of folds or wrinkles allows the package to increase in volume by unfolding, unwrinkling, or changing to a shape that includes a larger internal volume. The top drawing shows a “gable top” package that includes folds at a surface of a cube. The folds can unfold to expand from a flat surface to a three-dimensional pyramidal or trapezoidal shape, thereby increasing the total volume of the container. The lower picture illustrates an alternate package geometry that can start as a shortened cylinder having wrinkles or folds of a flexible material along sidewalls of the cylinder. As a dough composition in the package proofs and expands, the dough volume increases and causes the internal volume of the cylindrical package to also increase by unfolding the sidewall surfaces of the cylindrical package.

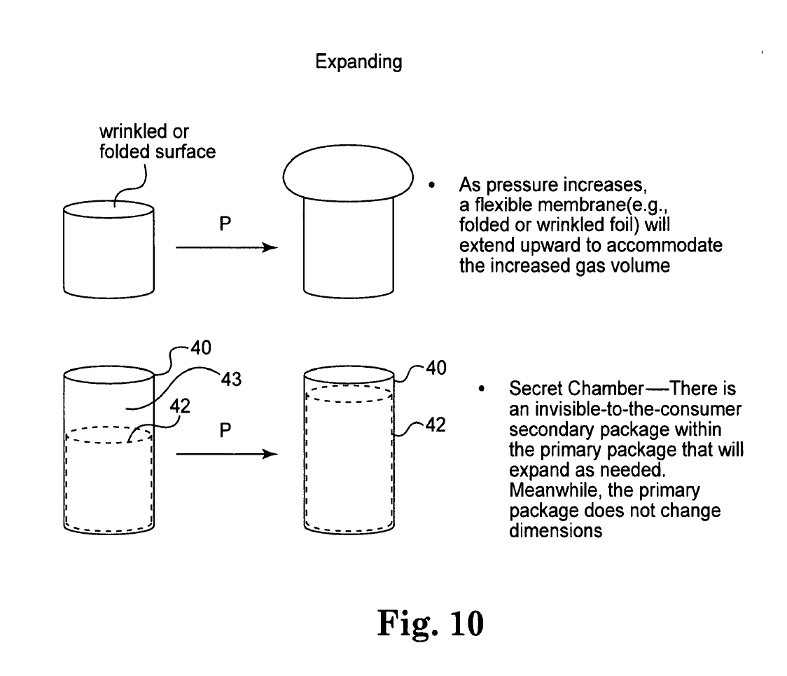

The upper diagram of FIG. 10 shows a cylindrical container that has a wrinkled or folded surface at a top or end of the cylinder. This wrinkled or folded surface includes a film such as a plastic or foil material that is folded and that can expand as illustrated to a larger volume upon expansion of the dough composition within the package.

The lower diagram of FIG. 10 shows a package that includes a primary outer package 40 and a secondary inner package 42. A dough composition is contained by inner package 42, which is also of a design that allows for expansion of inner package 42, and which can be non-vented. Outer package 40 is of a constant volume, and is optionally vented. As inner package 42 expands upon proofing and expansion of the dough composition contained therein, inner package 42 increases in volume and fills the complete volume of outer package 40, with optional venting of any gases contained in headspace 43 of the package, through vents, which are not shown.

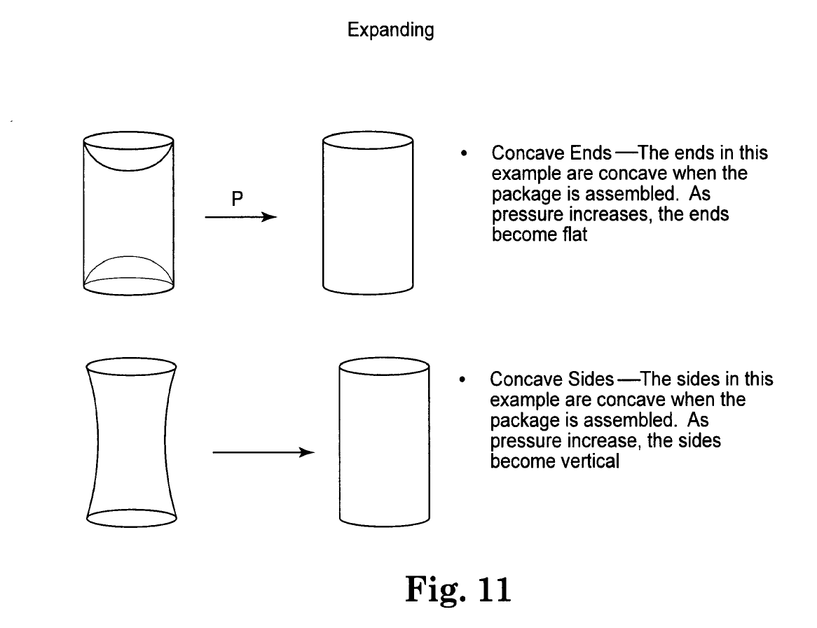

FIG. 11 shows two more examples of a cylindrical style container that has a variable, increasing volume, upon expansion of the dough composition inside of the container. The upper container includes concave ends that can change in shape to become flat or convex to increase the total volume of the container. The lower container includes concave sides that can also change in shape to become convex-cylindrical (with a larger total volume), cylindrical, or concave, to increase the total volume of the container. The material of the concave surfaces can be a flexible film that may be elastic or inelastic to optionally allow stretching or no stretching. Like other examples of containers that have a variable, increasing volume, these containers can be non-vented, and can become pressurized or can be at ambient pressure upon expansion of a dough within the container.

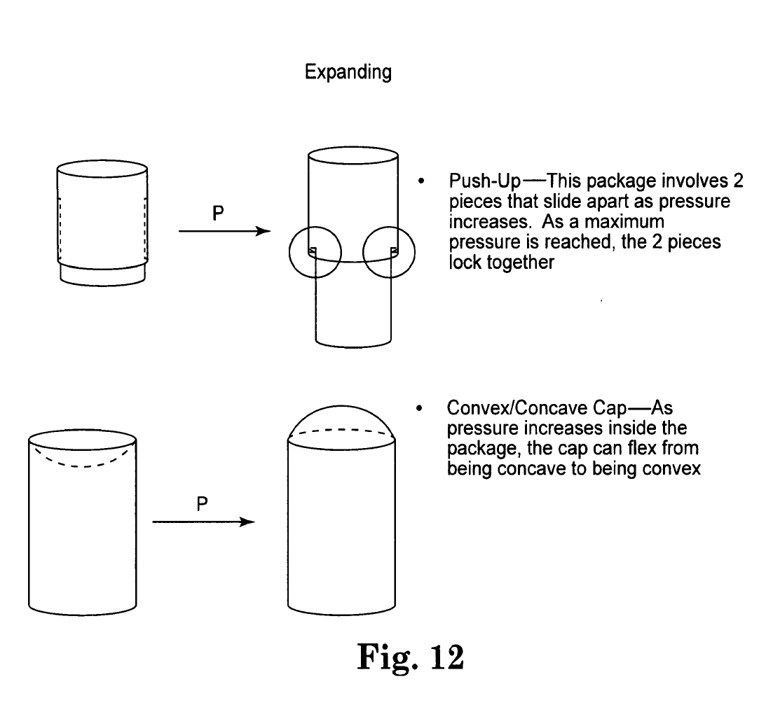

The upper illustration of FIG. 12 shows a different approach toward an expanding volume package. The package expands by telescoping, by two separate fixed-volume portions of the package sliding away from each other while dough inside of the package expands by proofing. This package may be vented or nonvented and may be pressurized or unpressurized upon proofing of the dough inside the container.

The lower illustration of FIG. 12 includes an embodiment as shown in FIG. 11, wherein one end of a cylinder changes shape from a flat or convex shape to a concave shape to increase volume of the container upon expansion of dough within.

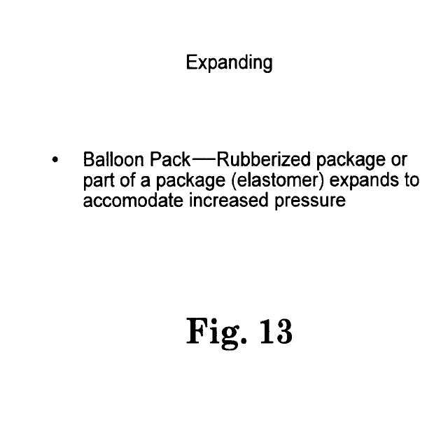

FIG. 13 describes that a package or a portion of a package can be elastomeric, to allow the package to expand by stretching to accommodate an increased volume of dough.

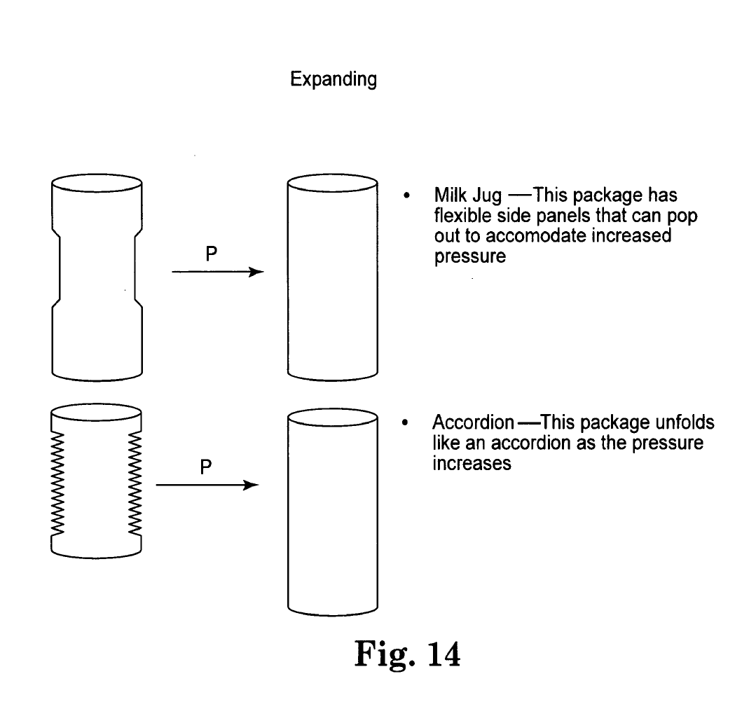

FIG. 14 exemplifies how packages with changing geometry and changing volume can optionally or additionally be evacuated using a vacuum during placement of a dough composition within the package. The package can be sealed and non-vented, or vented using a one-way valve. Expansion of a dough composition within the sealed package increases the volume of the dough, which causes the volume of the package to expand and increase from within, optionally with increased pressure due to the expanding dough composition.

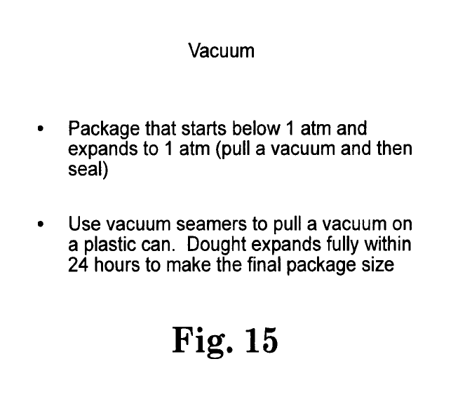

FIG. 15 identifies certain potential details of the use of vacuum. In specific, a dough package can be evacuated using vacuum to a negative pressure (below 1 atmosphere), and then sealed from outside (not in a “self-sealing” manner) at that negative internal pressure. The package can be non-vented or vented with a one-way valve. The negative internal pressure can induce expansion of the contained dough at a rate greater than expansion would occur at, e.g., ambient pressure. The dough can expand within the package to produce an internal pressure that may be an ambient pressure, a low pressure (0 to 15 psig, e.g., 5 to 10 psig), or to a pressurized condition (greater than 15 psig).

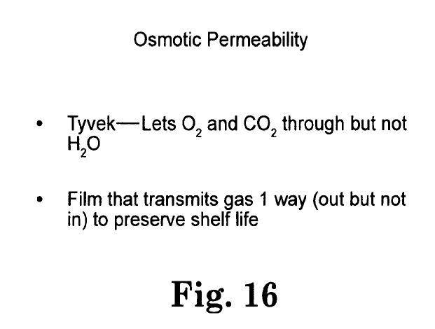

FIG. 16 shows that a package may contain a portion that will allow for osmotic permeability of gases to expel the gases from the interior of the package. A film or other osmotically permeable packaging material can be a sidewall, endcap of a fixed-volume container, an expandable or folded portion of a non-fixed-volume (expandable volume) container, etc. The osmotically permeable material can be flexible, elastomeric, rigid, semi-rigid, etc.

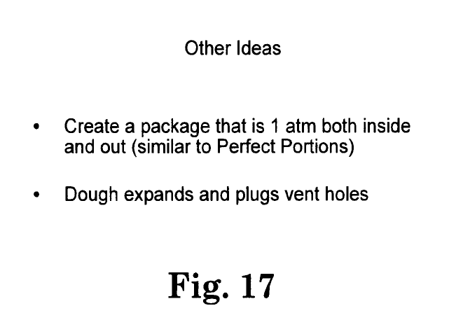

FIG. 17 described a general technique for sealing a package internally by allowing dough to expand after placement within a vented package, and the expanding dough contacts vents to seal the vents and prevent further venting.

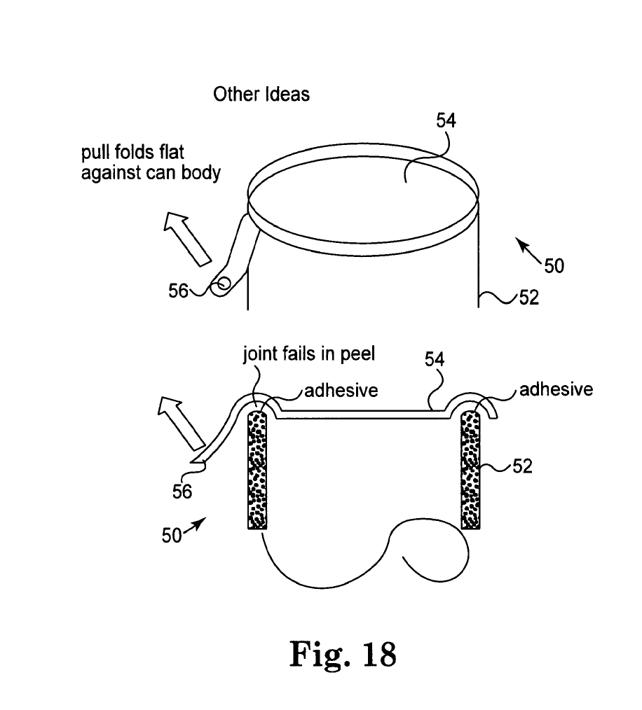

FIG. 18 shows an embodiment of a vented can that has an easy-to-open endcap. The can 50 includes sidewall 52 and end cap 54. The end cap is secured to ends of the sidewalls by an adhesive. The end cap can be removed by pulling tab 56 to overcome the force of the adhesive. The can may be vented or unvented and may be at a reduced pressure (e.g., 0 to 15 psig) or a pressurized (e.g., greater than 15 psig) condition. The can or canister may be plastic, paperboard, paper, metal, etc.; the end caps can also be of any of these materials. The venting can be any venting that is not inconsistent with the use of adhesive to secure the end cap to the side walls.

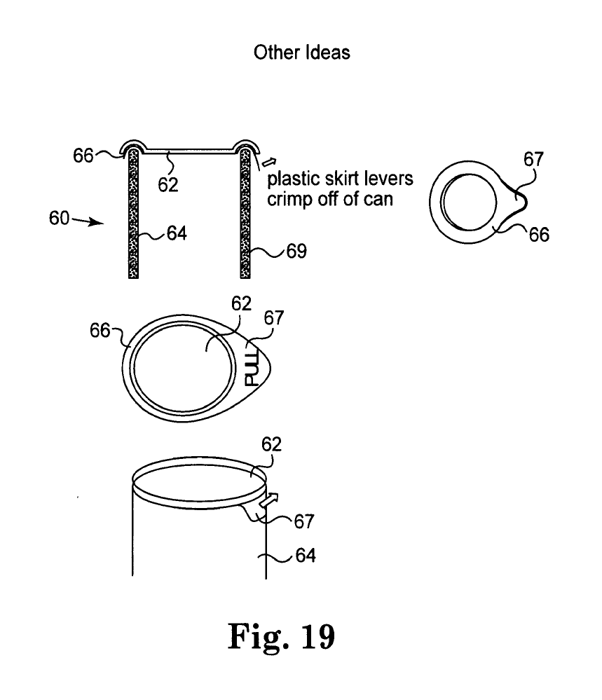

FIG. 19 shows another embodiment of a vented can that has an easy-to-open endcap. This embodiment is similar to the design of FIG. 18, and the design of FIG. 19 includes an additional piece, an annular “skirt” located between the ends of the sidewalls of the container and the endcap. In specific, package 60 includes endcap 62, sidewalls 64 and annular skirt 66, which includes tab 67. These pieces are assembled together by placing annular skirt 66 at the perimeter of sidewalls 64, and then placing endcap 62 to cover skirt 66. Endcap 62 can be crimped at its outside perimeter around the ends of side walls 64, with skirt 66 being crimped between the perimeter of endcap 62 and side walls 64. Skirt 66 is of a material such as a metal that can be flexed to allow the crimp to be undone by pulling on a tab (67) of the skirt.

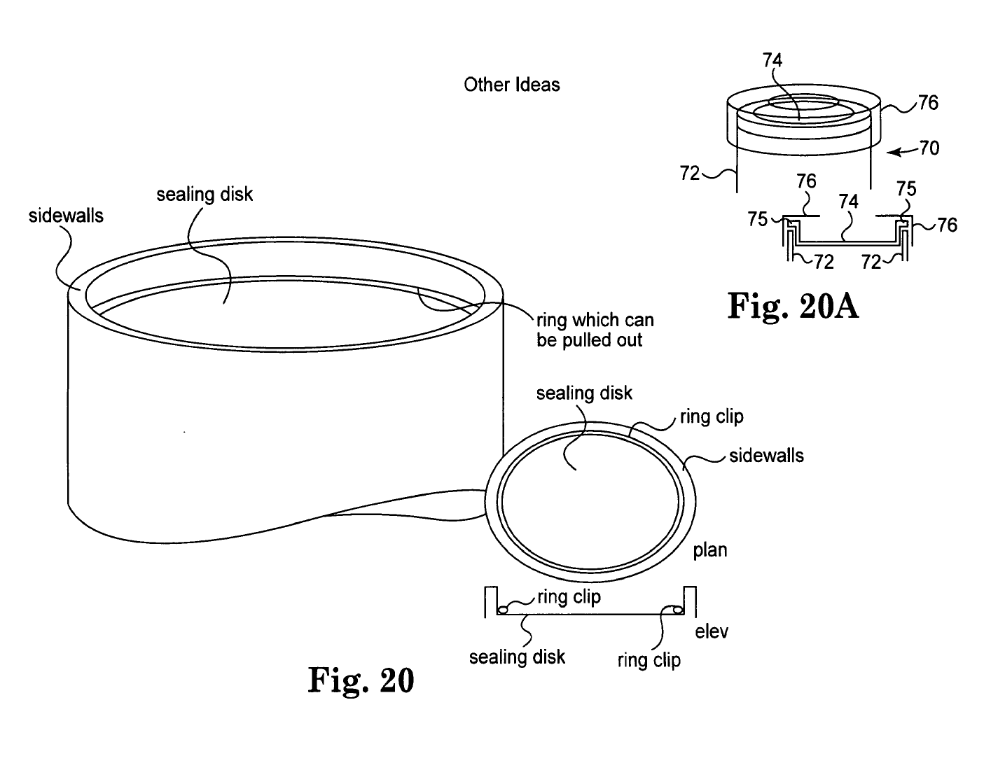

FIG. 20 shows another embodiment of a can or canister package sealed using a mechanical “ring” or a “ring clip.” The product package includes a cylindrical can or canister with sidewalls that contains a dough composition. A sealing disc is inserted at an end of the cylinder to cover the opening, the disc having a diameter and shape that substantially covers the opening. A “ring” or “ring clip” that is either separate from the disc or attached to the disc, holds the disc in place by frictionally engaging the interior surface of the sidewalls. The disc can be removed by removing the ring or ring clip to release the disc and open the package. The can may be vented or unvented, and pressurized or non-pressurized.

In an alternate embodiment, the ring or ring clip can be replaced by a different mechanical engagement, such as a shrink wrap that is placed on the outside of the package to secure the position of the sealing disc. A “shrink wrap” is a heat sensitive plastic material that can be placed around the end of the package and heated, to shrink and conform to the end of the package and mechanically hold an end cap on the end of the cylinder sidewalls. FIG. 20A illustrates an end of a cylindrical package 70 that includes sidewalls 72, end cap 74, and plastic shrink wrap 76. Cylinder sidewalls 72 are covered by end cap 74, which includes lips 75 that extend laterally at least partially past sidewalls 72. Shrink wrap 74 is wrapped around the assembled cylinder and end cap, to keep end cap secure to the package. To remove the dough, the shrink wrap is removed and the end cap is removed. Like other exemplary fixed-volume packages discussed herein, this package may be vented and either pressurized or non-pressurized during refrigerated storage of a proofed or partially proofed dough.

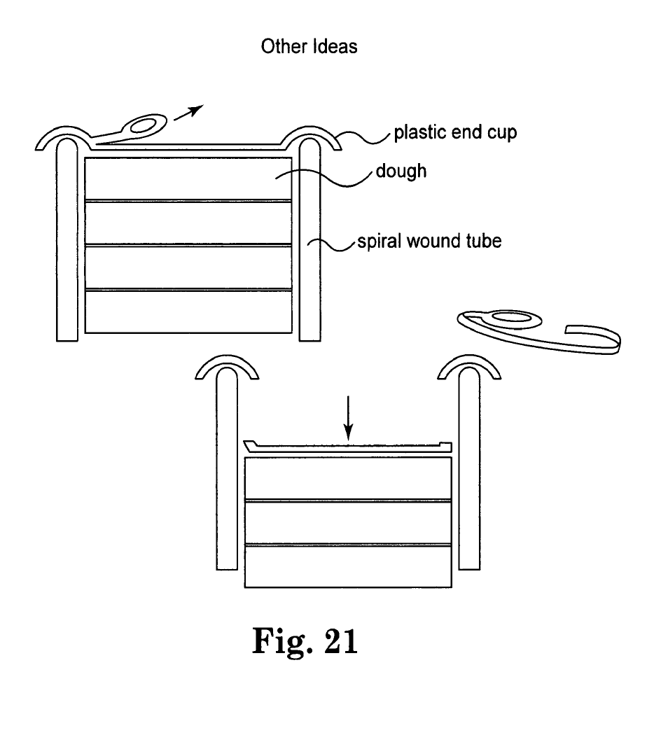

FIG. 21 illustrates an example of an end portion of a cylindrical can. The can is sealed by a multi-piece endcap that is scored to allow the endcap to be pulled apart into multiple separate pieces or segments. The endcap is secured to the sidewalls, such as by crimping or by use of an adhesive. To open the package, a tab on the endcap is pulled away from the package to cause the endcap to come apart in pieces along score lines. In the illustrated embodiment, the tab attaches to an annular pull-away portion, and an inner region of the endcap remains as a disc that contacts the dough inside of the package. The disc can be used to push the dough out of the opposite side of the cylindrical package (see arrow).

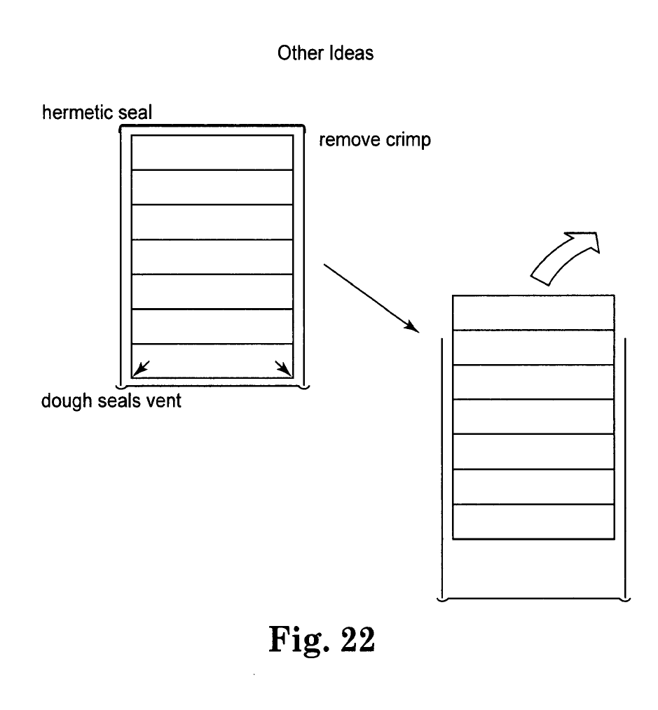

FIG. 22 shows an optional feature of a package as described, which is a vent at one and of a package that allows pressure equalization as a dough composition is removed from the opposite end. In specific, one end of a package (pictured as the top, which is hermetically sealed) is closed and sealed by any endcap or sealing mechanism described herein, such as with a crimped endcap or an adhesively-sealed endcap, to produce a non-vented, openable, sealed closure. The other end includes a vent that is sealed internally by a self-sealing mechanism based on dough expanding to seal a self-sealing vent. To remove the dough, the top (as illustrated) end of the can is opened, and the dough is removed, and during removal, pressure within the container is equalized by gas flowing into the package through the vented end at the bottom of the container. Equalized pressure allows the dough to be removed more easily from the can.

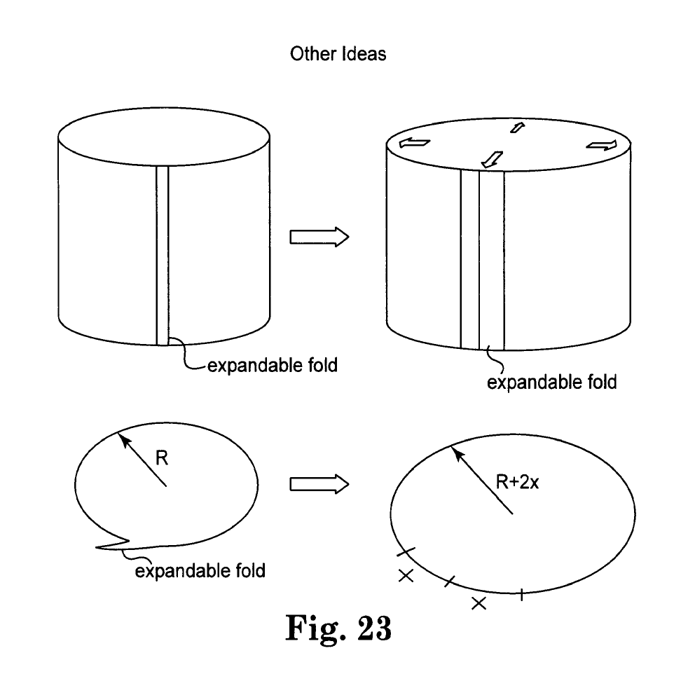

FIG. 23 illustrates a variable-volume cylindrical package that includes cylinder sidewalls having an expandable fold or wrinkle The package includes an expandable fold or wrinkle along a length of the side portion of the package. The fold or wrinkle unfolds to accommodate the increasing volume of contained dough. The top set of diagrams of FIG. 23 shows the expandable fold opening from a side perspective view. The bottom set of diagrams of FIG. 23 shows the expandable folder opening from a top. The package also accommodates an increasing diameter end, at both ends of the cylinder, as the cylinder expands circumferentially.

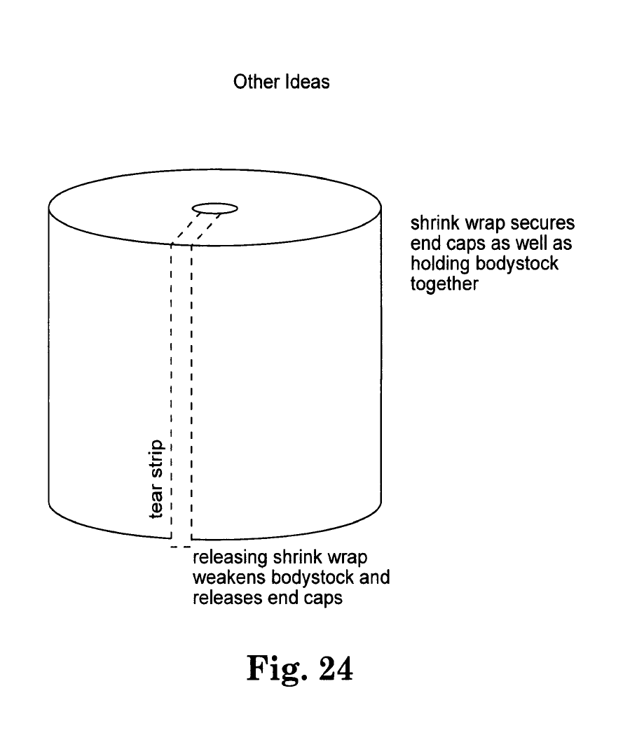

FIG. 24 shows an example of a package that is closed and secured using shrinkwrap to hold together and assembled package. The package is illustrated to be cylindrical but could be of any geometry. As illustrated, an exemplary package can include a tube (which may be cylindrical or otherwise) of paperboard or plastic, and endcaps to cover ends of the tube that contains a dough composition. A plastic shrink wrap outer layer can be used to hold the endcaps against the ends of the tube during a period of refrigeration. A perforated portion or tear strip can be included on the shrinkwrap material, to allow the shrinkwrap to be easily removed and the container opened. The container can be of a fixed or of an expandable volume and may be pressurized or non-pressurized, vented or non-vented.

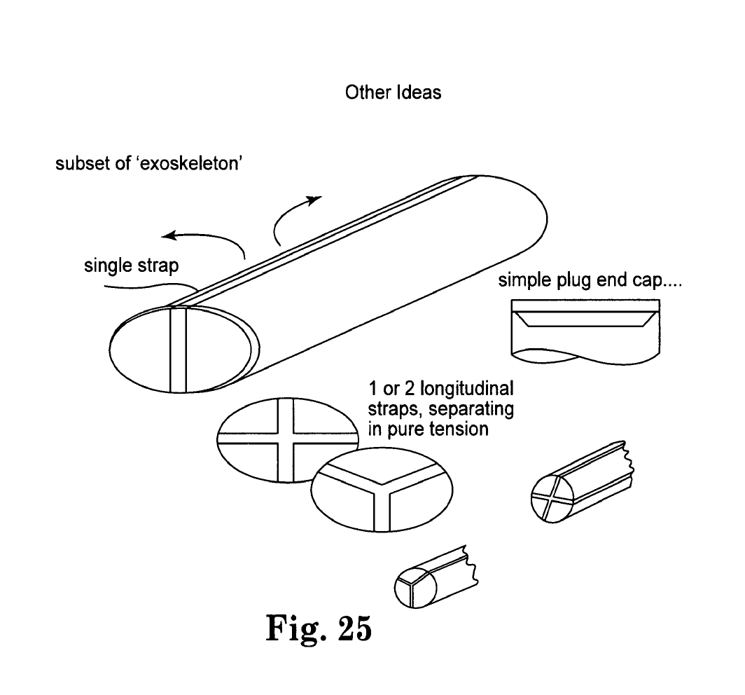

FIG. 25 shows another alternate embodiment for securing a removable end or end cap to a closed package as described herein (e.g., vented, non-vented, pressurized, non-pressurized). The illustrated package is cylindrical but could be of any geometry. End caps are placed over open ends of the package and are held in place by straps, which may be elastic or inelastic. FIG. 25 illustrates examples of a single strap that wraps one time around the cylinder by passing the length of the cylinder two times (one time on each side of the package) and traverses each end cap one time. Other configurations are also possible using an elastic or inelastic strap to hold end caps to a package, such as straps that extend along the length of the package three times and four times (see other examples of packages at FIG. 25).

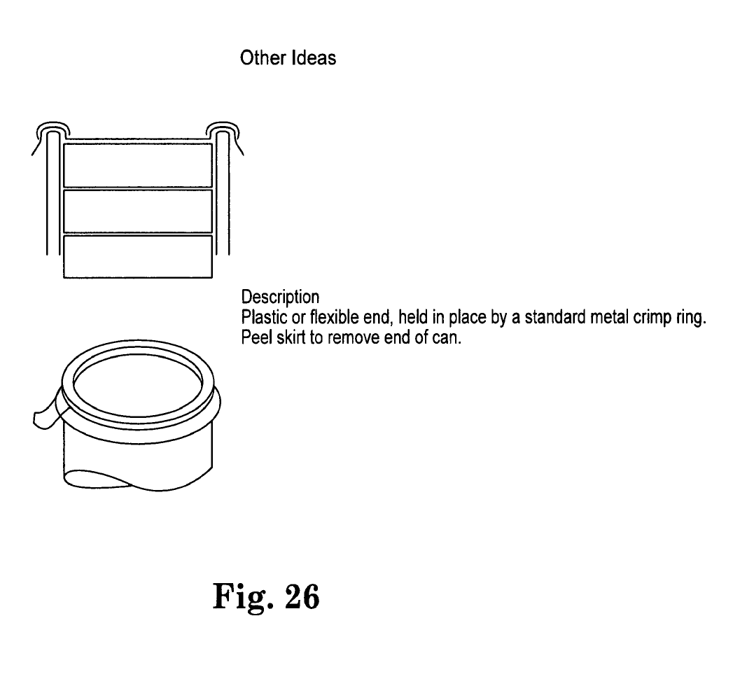

FIG. 26 shows another embodiment for securing a removable end or end cap to a closed package as described herein (e.g., vented, non-vented, pressurized, non-pressurized). The package includes an endcap that can be removed by tearing a strip from around the circumference of the package, in the region of the end of sidewalls, to loosen and detach the end or endcap. Various designs can be used to allow removal of the end or endcap by tearing a strip or pieces of packaging near the end. The endcap may be metal crimped around its perimeter over a plastic strip and over the endwalls of the package. To open the package by removing the endcap, the plastic strip can be pulled from beneath the crimped endcap by pulling a tab, which loosens the endcap. In an alternate embodiment, a package (cylindrical can), strip, and endcap can be made of plastic. A pull-away strip is attached to both the package sidewall and the end cap, and is scored around the perimeter of both. The strip can be torn or broken away from the endcap and package by pulling a tab and unwrapping around the package circumference, to allow the endcap to be released from the package and removed to open the package.

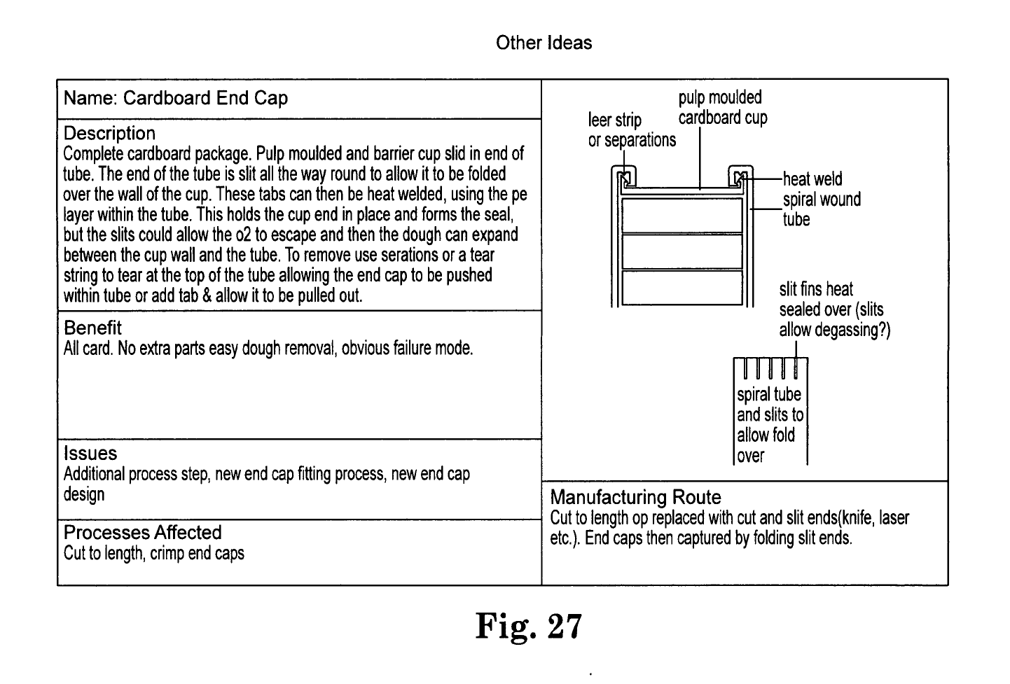

FIG. 27 shows an example of an all-paperboard package as otherwise described herein. A spiral tube (e.g., made of paperboard) is sealed at one end by a paperboard cup or disc covering the open cylindrical end. Ends of the sidewalls are folded over the cup or disc to secure the paperboard cup in place. An optional adhesive or mechanical securing mechanism may be used to secure the folds. For example a thermoplastic (e.g., polyethylene) can be used to secure the folds, or to further seal or secure the end of the container. A tear strip can be included within the folded end to allow separation of the paperboard cup from the sidewalls at a desired time to open the package and remove dough contents.

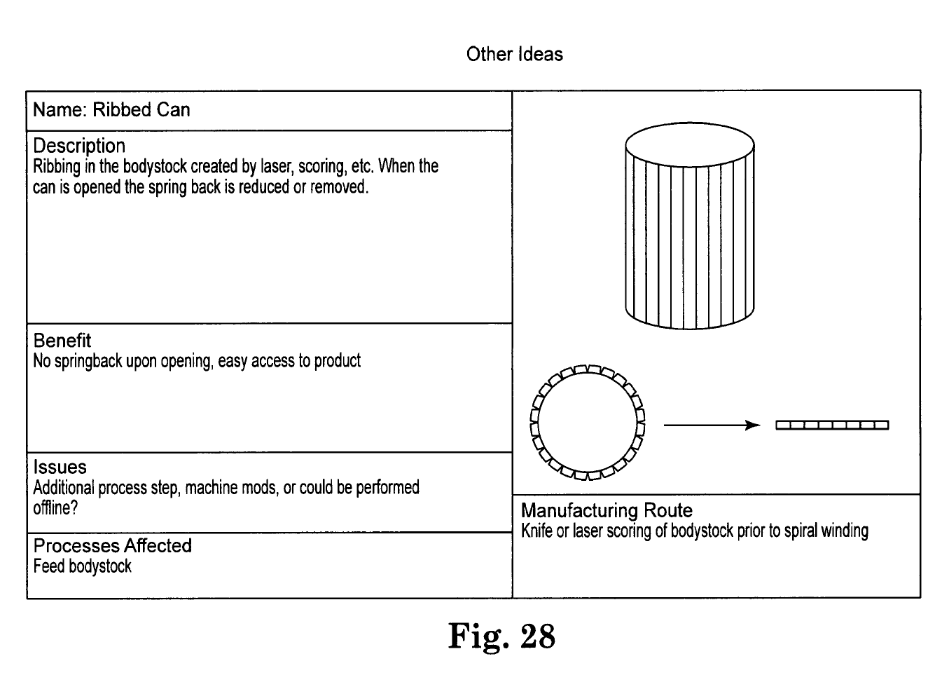

FIG. 28 illustrates a feature of a paperboard or plastic material used to prepare a wound can or canister. Addition of ribs or scored lines at a surface of the can is useful to prevent “springback” of the material upon opening. “Springback” is the tendency of a wound cylindrical package such as a can or canister to maintain its cylindrical shaped during opening. Springback is a resistance of the package to the act of opening the package by unwinding the spiral. Ribs or scoring as illustrated can reduce this springback pressure. The ribs or scoring improve the ability of the packaging material to be unwound or to lie flat when unwound. This can be useful with pressurized or non-pressurized containers.

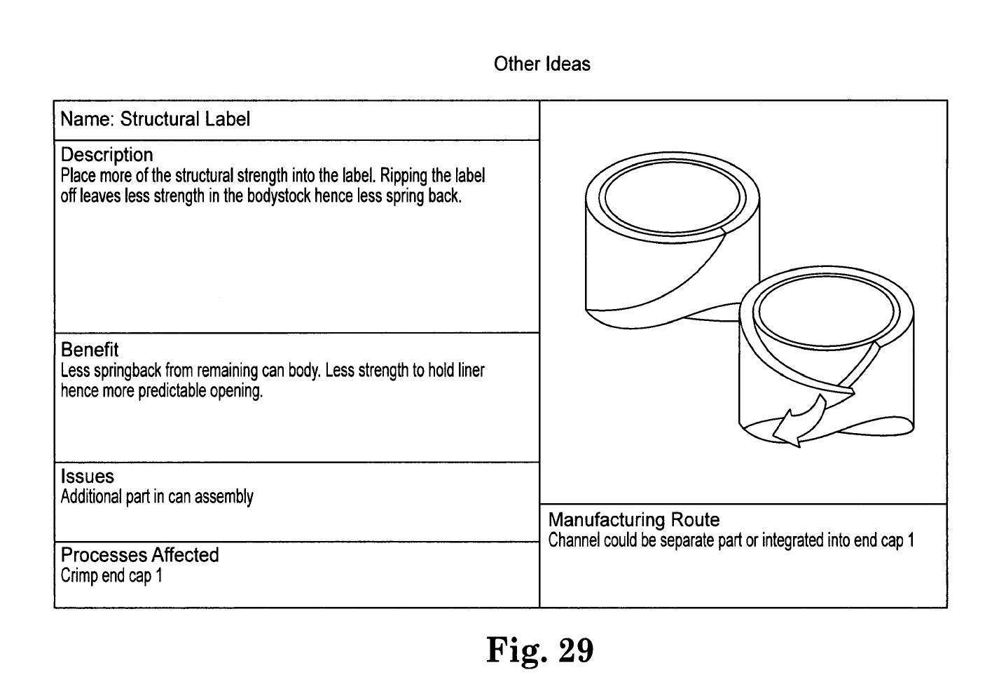

FIG. 29 describes the use of a thinner paperboard layer as one constituent of a wound paper or paperboard package. Wound packages can include an inner plastic layer, a paperboard layer, and an external label layer that may include a with or information such as packaging contents or instructions for use. The plastic and paperboard layers conventionally provide a substantial amount of structural strength for the closed container. An embodiment of the invention places more structural strength in the label later, at the external layer of the packaging material. During opening, the external (labeling) layer is removed. Making the external packaging layer out of a relatively increased strength material allows the inner paperboard layer to be of reduced structural strength, which can allow for a wound package design that opens easier upon removal of the external labeling layer. Easier opening of the package upon removal of the labeling layer is beneficial with non-pressurized packages.

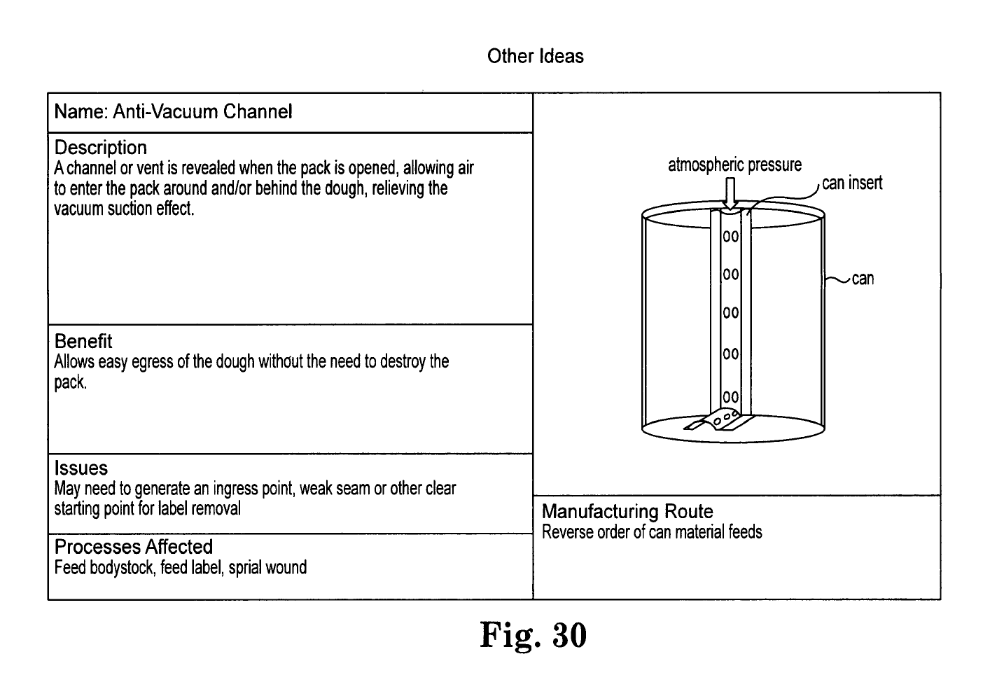

FIG. 30 shows another embodiment of a feature that allows pressure equalization as a dough composition during removal of the dough from a package after opening. A channel extends from the opened end to the far end of the package (illustrated as a cylinder), and the channel allows the can to achieve atmospheric pressure at the far (closed) end of the can to improve the ability of dough to be taken from the opened package.

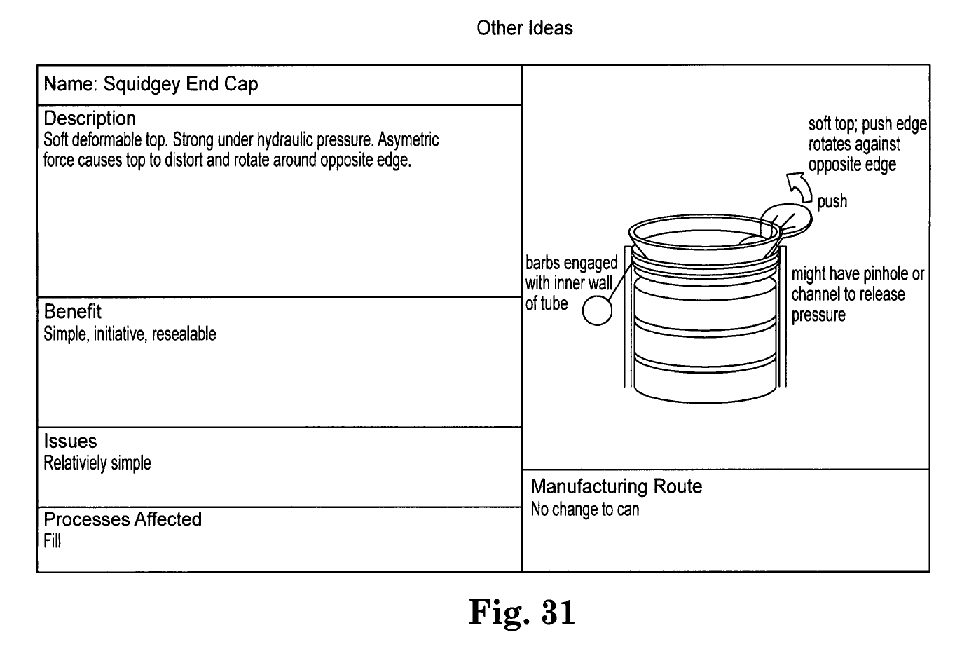

FIG. 31 illustrates a flexible endcap that can be used to close an open end of a plastic, metal, or paperboard package, such as tube of a cylindrical shape or other elongate shape. The flexible endcap can engage the interior portion of the package using ribbed or other types of extending, frictionally-engaging surfaces located at the interior side wall surface, on a surface of the perimeter of endcap, or at both surfaces. The endcap is made of a flexible material such as a soft rubber or polymer and can be removed by lifting away from the package, optionally with deformation.

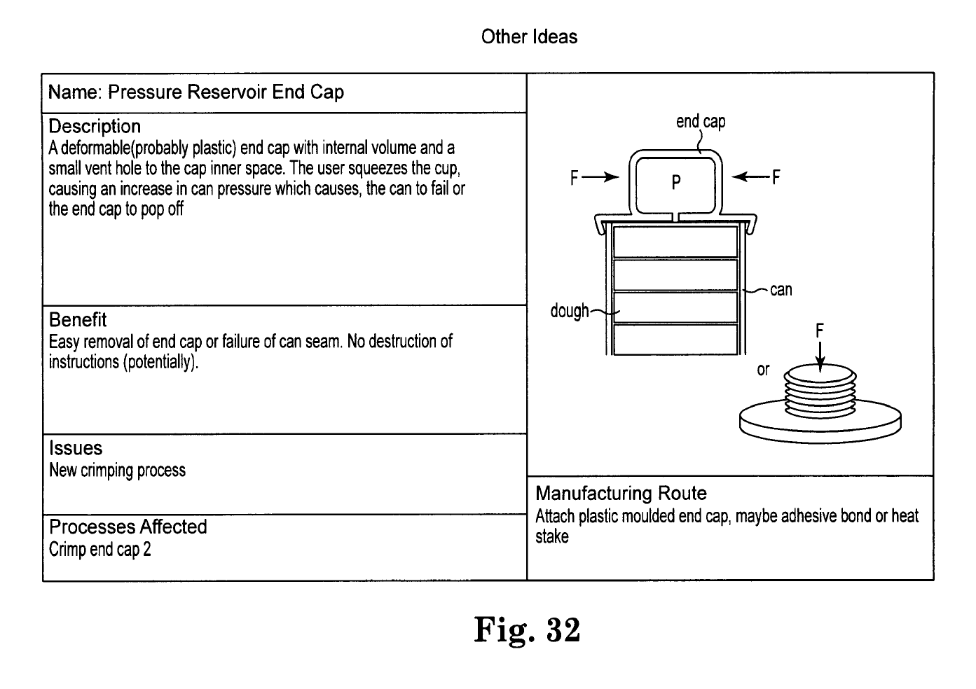

FIG. 32 shows an example of an endcap that includes a pressure reservoir. The pressure reservoir is made of a flexible material such as plastic or another flexible polymer or rubber. The endcap is attached to an end of a package in a manner that produces a seam that will fail by squeezing the pressure reservoir, which increases the pressure inside of the container.

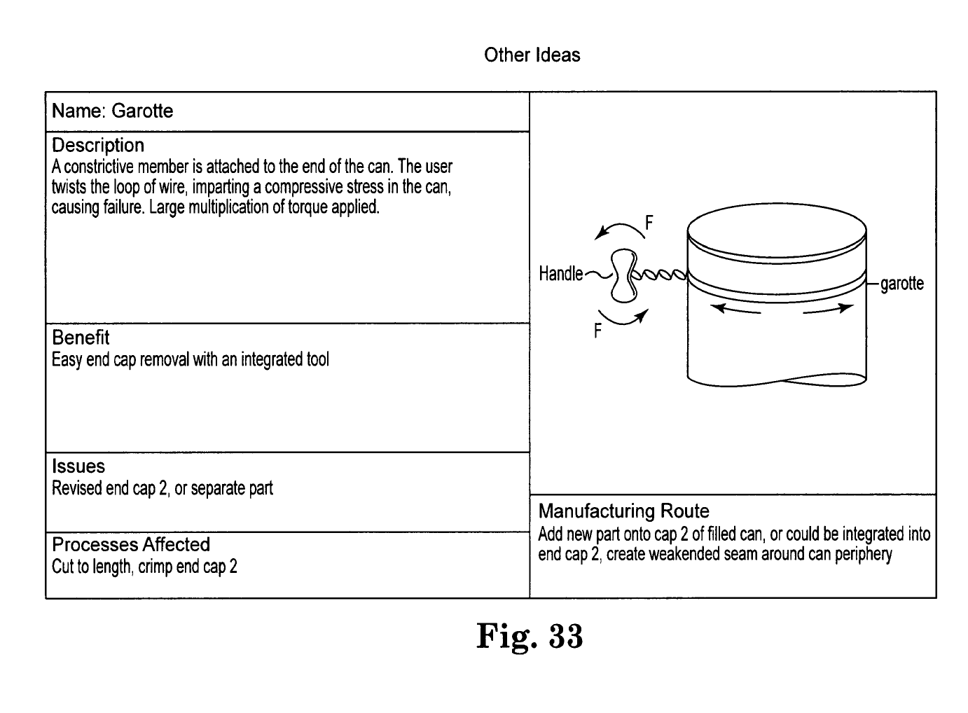

FIG. 33 shows a method of opening a package using a tool to unwind an elongate strip or wire. The package includes a seam that is integrated with the wire or strip such as an inelastic flexible strip of wire or cord. A tool, which optionally is sold with the package, engages the wire, strip, or cord. The tool can be twisted or turned using a handle, causing the wire, strip, or cord to become wrapped around the tool and disengaged from the package, to open a seam in the package.

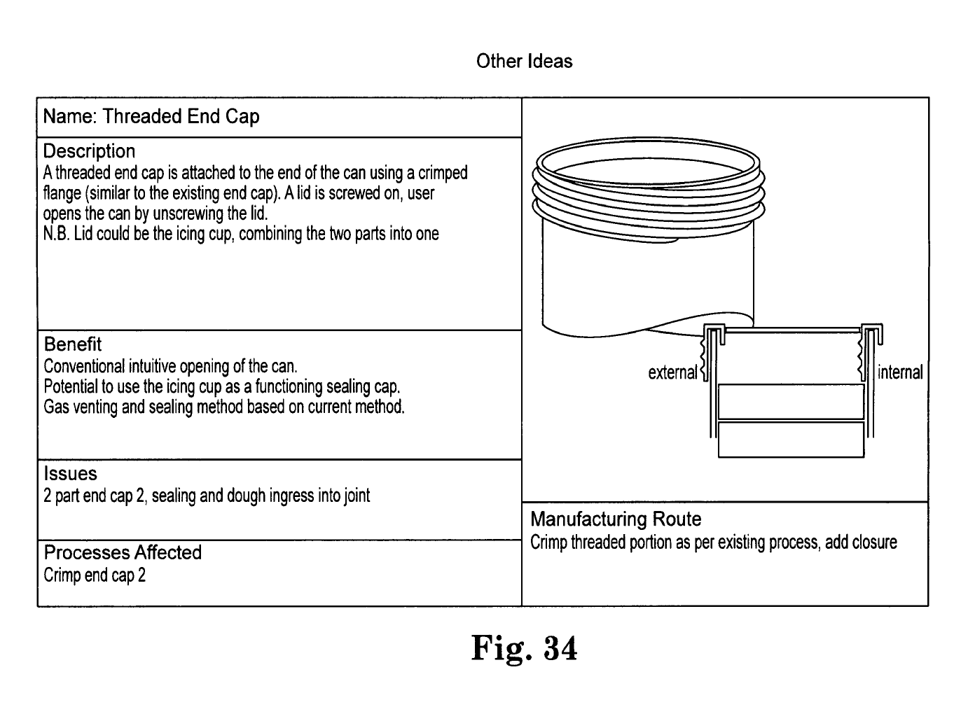

FIG. 34 illustrates a threaded package closing configuration for use at an end of a cylindrical package configuration, such as a package described herein to be vented, non-vented, pressurized, non-pressurized, etc. Threads may be used to allow an endcap to engage a cylindrical end of a package. The threads may be internal to the endcap, external to the endcap, internal to the cylindrical sidewalls, or external to the cylindrical sidewalls. The cylinder may be metal, plastic, or paperboard or paperboard, as can be the endcap.

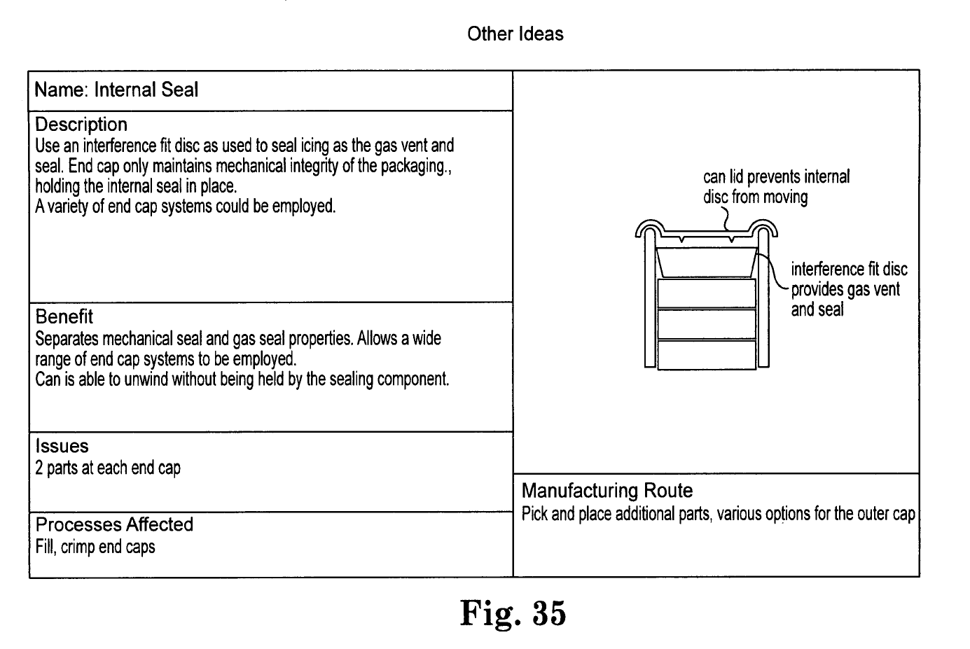

FIG. 35 illustrates a package configuration that includes an internal disk to provide gas venting and sealing function, and a external lid or endcap that allows for mechanical integrity of the packaging. The external endcap is not required to provide a sealing function. The internal disk can provide gas venting functions by any means such as vents, channels, tortuous path, as described herein or otherwise; the disk may provide sealing functions by mechanical or self-sealing mechanisms as described herein or otherwise.

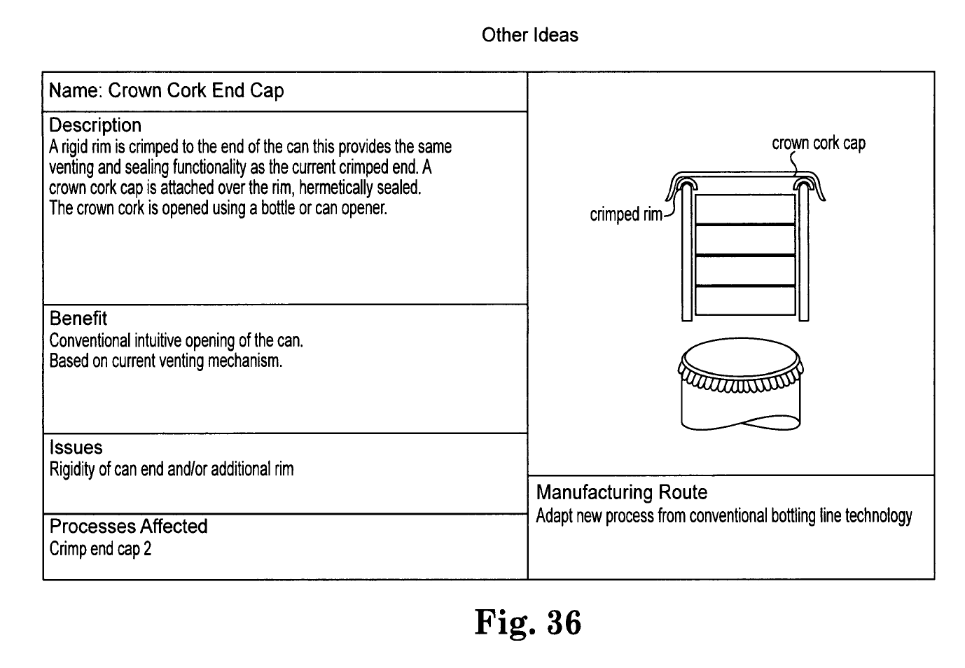

FIG. 36 illustrates an embodiment of a sealed cylinder end that includes a crimped rim and a crown cap. The end can be opened using conventional bottle cap or can opener.

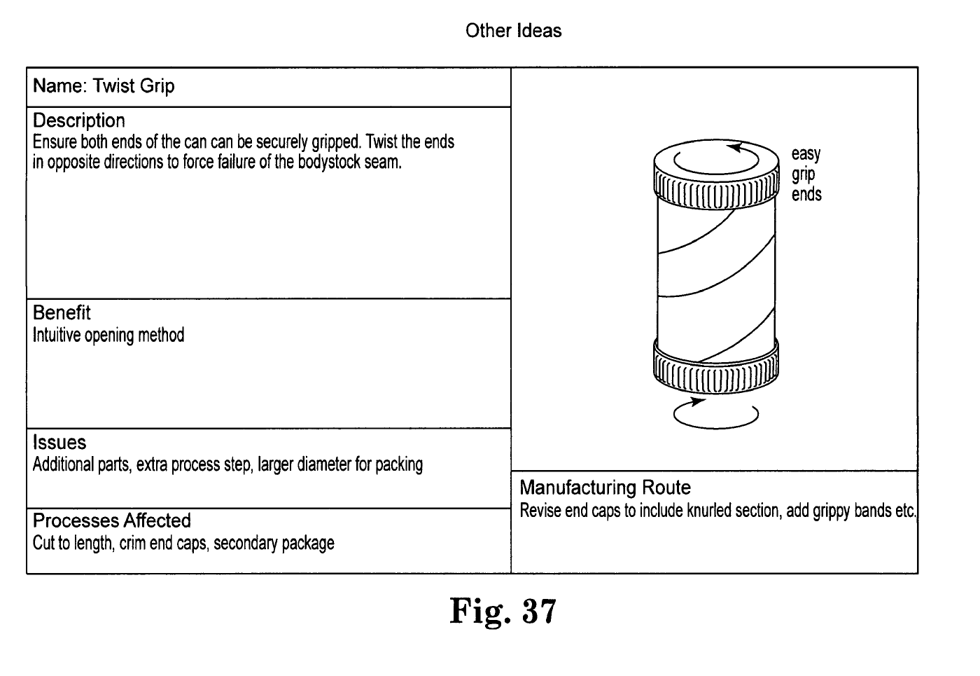

FIG. 37 illustrates an embodiment of a sealed cylinder end that includes a frictional grip that allows secure handling of the ends. The ends can twist in opposite directions to open the wound package by breaking the bond of the wound material at a seam.

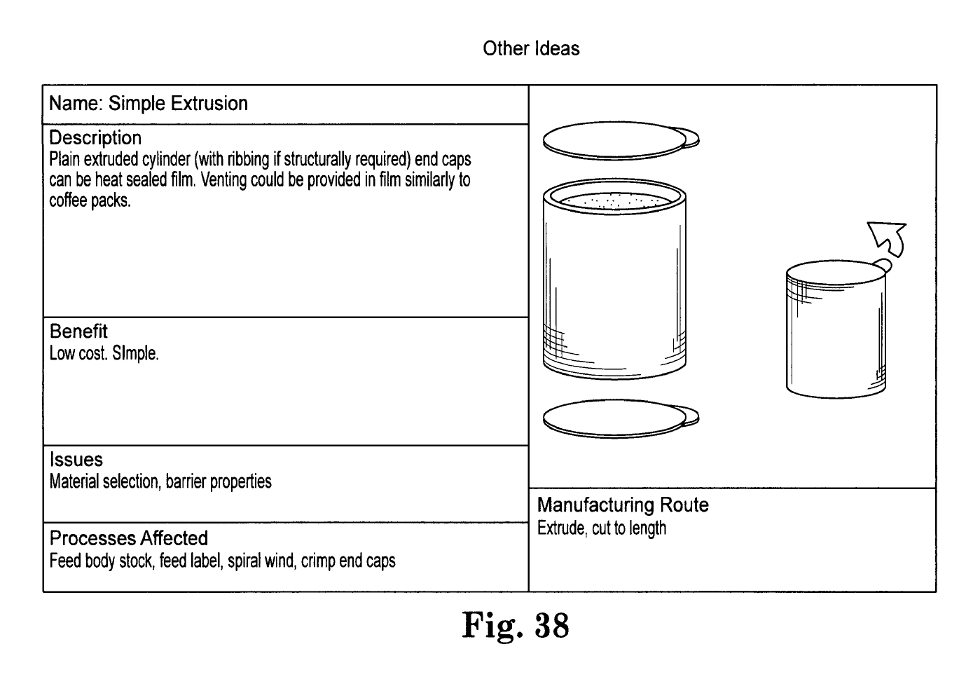

FIG. 38 shows an example of a sealed package, the package being made from an extruded cylinder, the end having a lip that can attach to an end cap in the form of a film or sheet. The endcap can be secured to the lip by heat sealing or adhesive.

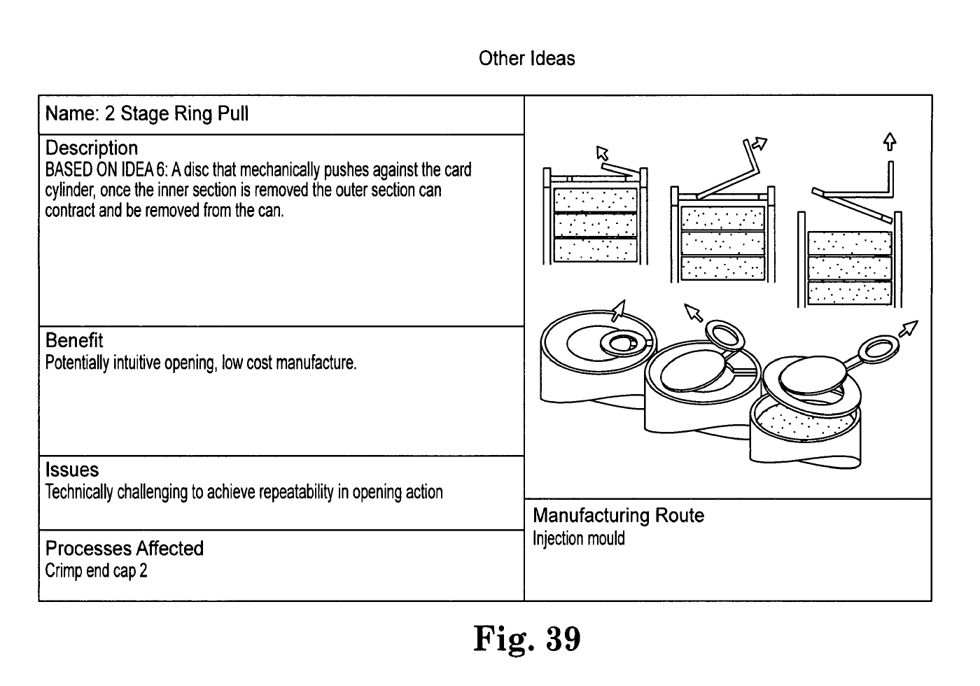

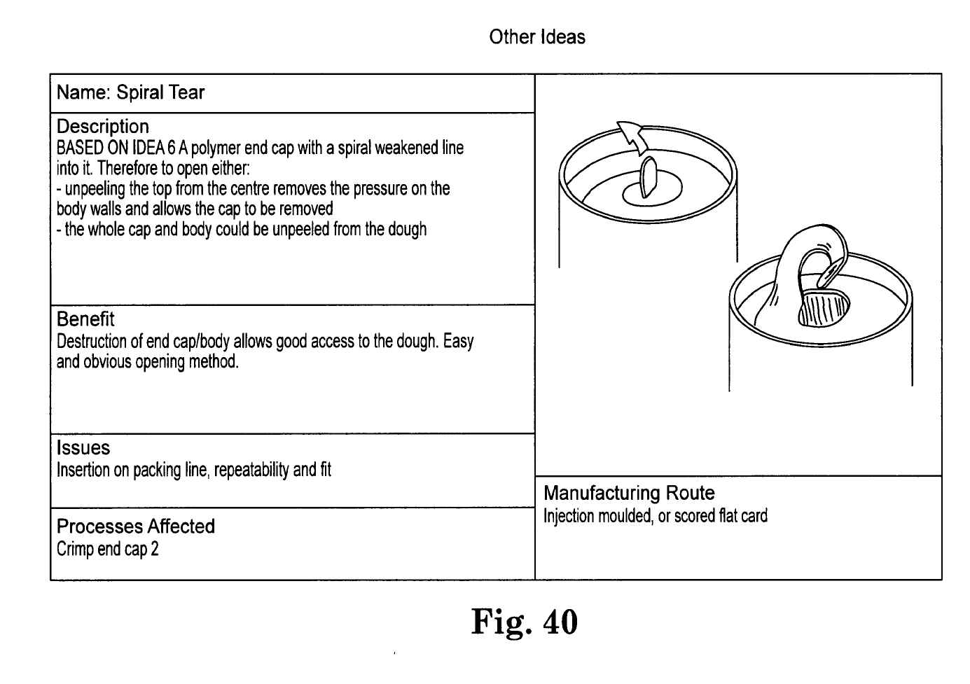

FIG. 39 illustrates an example of a plastic or metal end cap that attached at a perimeter of a cylinder and that can be removed in multiple sections or pieces. The cylinder may be paperboard, plastic, or metal, and the end cap may be attached by crimping, thermoforming, heat sealing, adhesive, or the like. The plastic or metal endcap includes scoring or other weakening to allow a section of the end to be pulled using a tab (e.g., circular pull tab) so the end cap peels or tears away in sections to open the end of the package. FIG. 40 shows a similar embodiment with weakening or scoring of the end cap to allow the endcap to be opened in a spiral fashion.

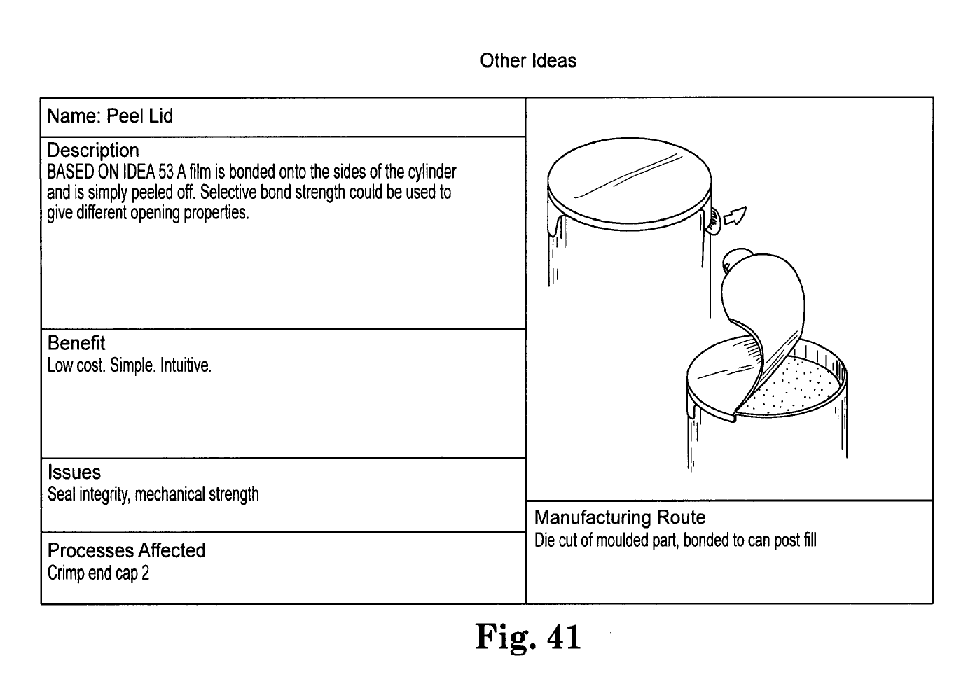

FIG. 41 shows another embodiment of a package that includes a film or sheet that covers an end cap. The film or sheet is attached to the end of the package by, e.g., heat sealing or adhesive. The end cap can be removed by pulling on a tab to overcome the adhesive force.

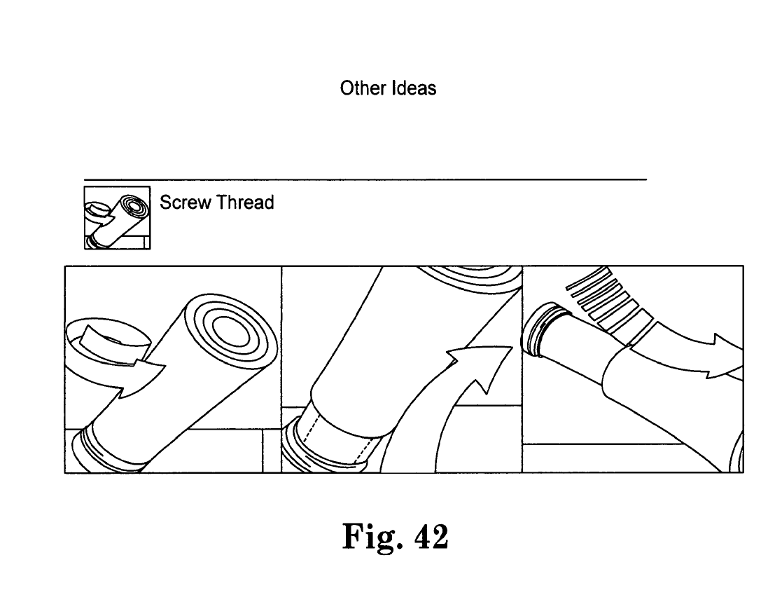

FIG. 42 shows the use of screw thread end cap such as illustrated at FIG. 34. The package of FIG. 42 can optionally also include a feature to equalize pressure within the container to allow the dough to be removed, such as described herein.

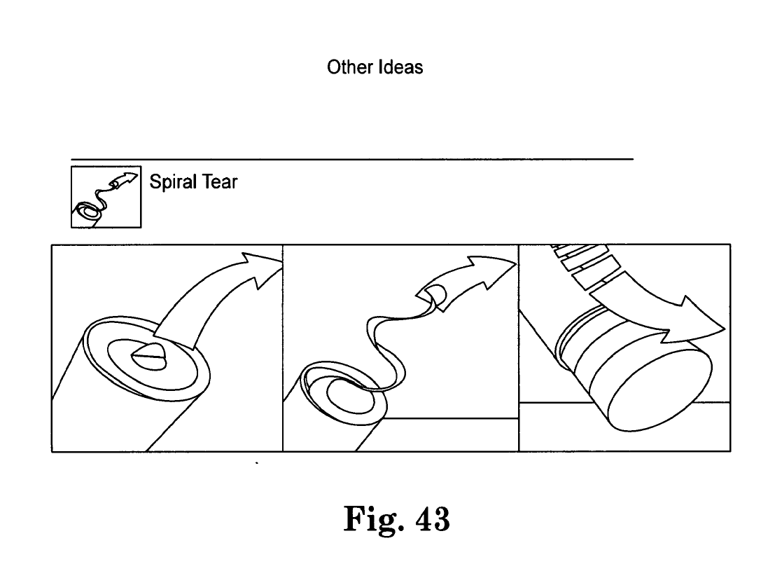

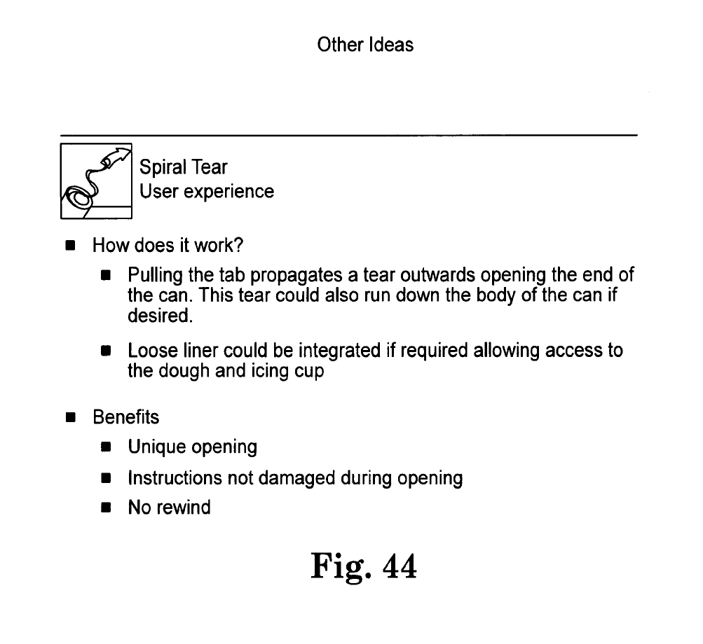

FIG. 43 illustrates the endcap of FIG. 40, which can be opened by a spiral tear of a scored or weakened endcap. FIG. 44 describes additional, optional features of this embodiment, and possible benefits to a user.

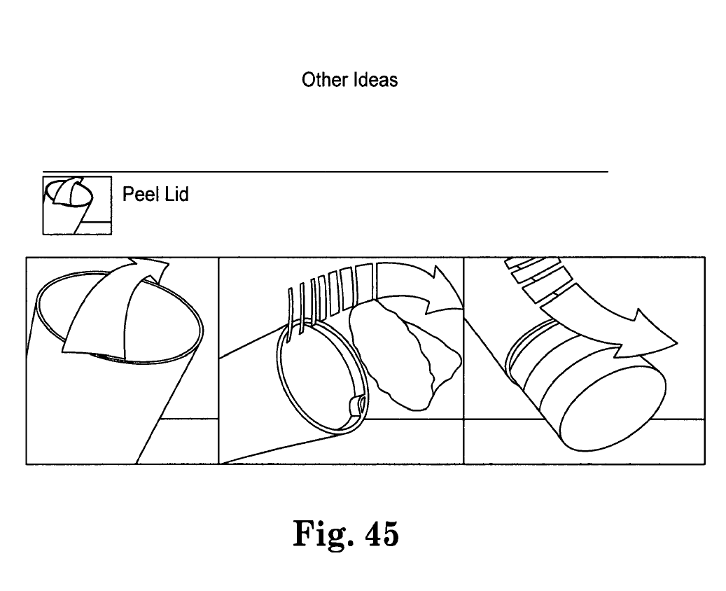

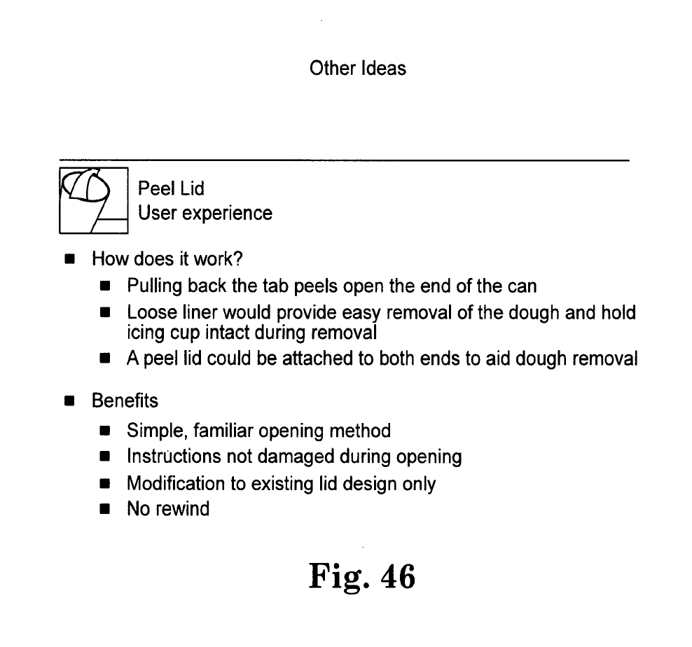

FIG. 45 illustrates a use of a package having a peelable lid, such as described herein (e.g., at FIG. 41), in combination with a pressure equalizer (e.g., at FIG. 30). The combination allows for removal of dough portions out the opened end, with pressure equalization at the closed end. FIG. 46 describes exemplary manners of uses of a peelable lid, various use configurations, and possible advantages.

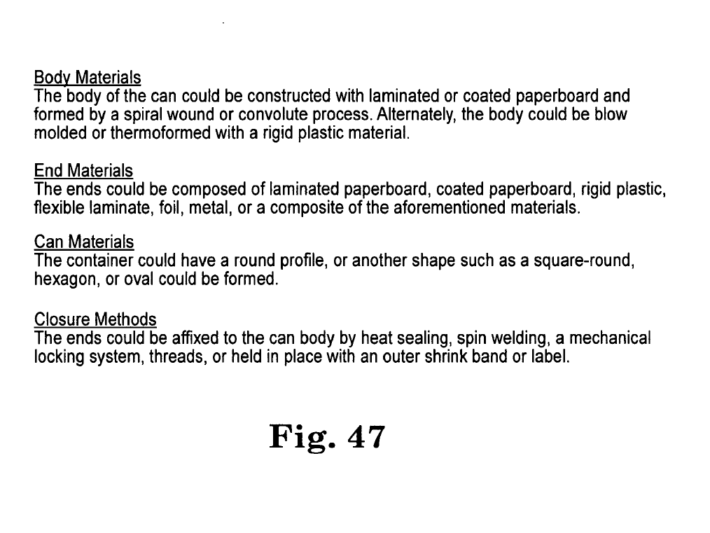

FIG. 47 includes a discussion of packaging materials, geometry, and closure methods, that can be useful with packages, e.g., low pressure packages, in combination with other features described herein.

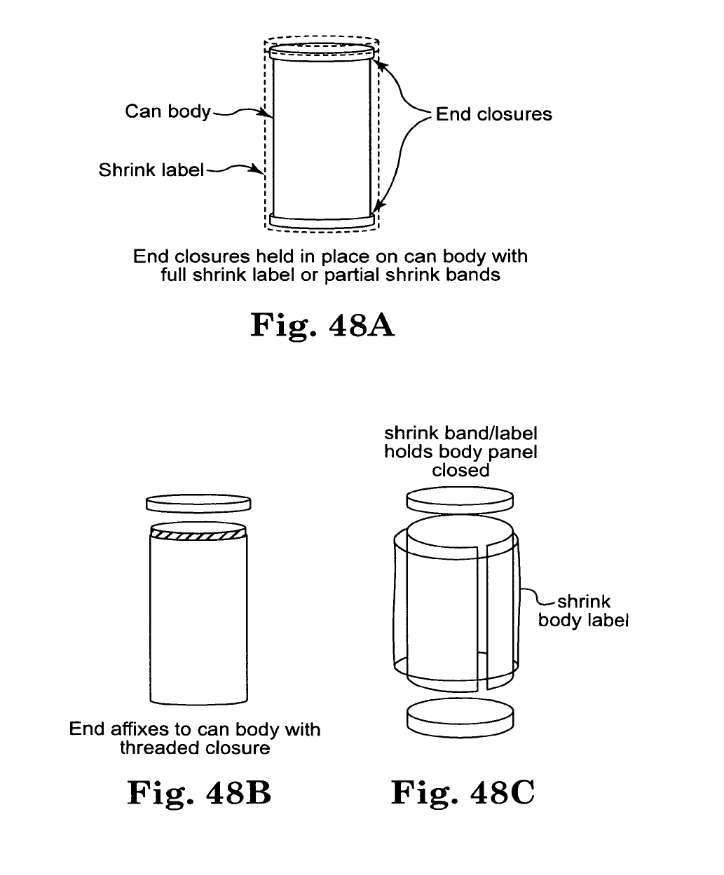

FIG. 48 illustrates cylindrical containers with endcaps held in place by a shrinkwrap label (48A); an endcap held to a package by a threaded closure (48B); and a package that has endcaps secured to a container by any method, with a package body held in place using shrinkwrap that can optionally include labeling information (48C).

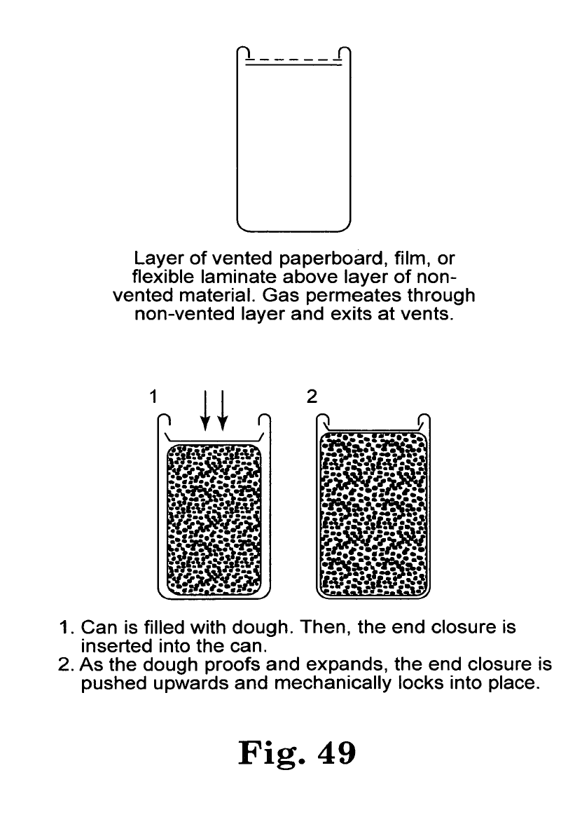

FIG. 49 illustrates structures and methods of sealing a vented package by expansion of dough internally to close a vent from within by pressure on a mechanical structure (e.g., as described generally at FIGS. 5, 6, 7, and 8). The can may be pressurized or non-pressurized after the dough has expanded inside of the package.

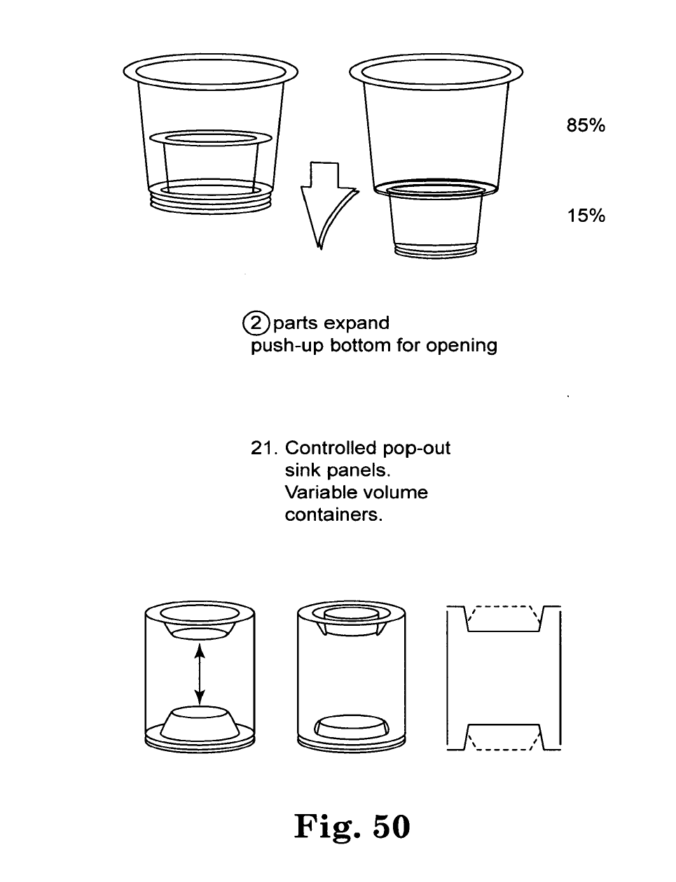

FIG. 50 illustrates structures and methods related to expanding-volume packages that can increase in volume to accommodate a dough composition that expands during proofing within the package (see, e.g., FIGS. 9, 10, 11, 12, 13, 14, and 15). The can may be pressurized or non-pressurized after the dough has expanded inside of the package.

Specific embodiments of the invention can included the following, as well as methods of preparing and using these packaged dough compositions.

A refrigerator stable, packaged, pre-proofed chemically leavened dough composition as described herein, optionally in a low pressure package, wherein the package comprises any one or a combination of the following:

a vent that comprises a tortuous path;

a vented chamber whose vent becomes closed mechanically by contact with expanding dough inside of the package; for example the vent may be closed by a ball valve or a hinged or spring-biased mechanical closure;

a non-vented package that expands to accommodate a dough of expanding volume within the container; the package may expand by a changing shape or by a fold or wrinkle becoming un-folded or un-wrinkled (with our without stretching), or by stretching;

an interior that is sealed to contain an unproofed dough, with the internal pressure of the sealed package being less than 1 atmosphere (gauge), i.e. from zero to 1 atmosphere gauge;

a package portion that is osmotically-permeable

a package that includes an endcap that is a flexible sheet of plastic, metal, or foil adhered to a sidewall end by adhesive or thermal sealing, and that can be removed by pulling to peel the end cap from the sidewall end;

a package that includes an endcap that is a flexible sheet of plastic, metal, or foil adhered to a sidewall end by adhesive or thermal sealing, with an annular skirt between the endcap and the sidewall, and that can be removed by pulling on the skirt to peel the skirt and endcap from the sidewall end;

a package that includes an endcap that in the form of a plastic, metal, or foil sheet adhered or crimped to a sidewall end, the endcap being scored to allow the endcap to be pulled apart into one or more pieces or sections;

a package that includes an openable end at one end of a tube and a vented end at another end of the tube, to allow for pressure equalization during removal of a dough composition from the openable end of the tube;

a package that is sealed or that has pieces held together by a shrink wrap;

a package that has pieces held together by straps;

a package that can be opened by pulling a strip of material around a circumference of an endcap to loosen the endcap;

an all paperboard package that includes a paperboard tube and a paperboard endcap; the paperboard tube can be folded to mechanically secure the endcap in place;

a package that comprises wound plastic, metal, or paperboard, the wound material including scoring that improves the ability of the wound material to open and lie flat;

a package that comprises three layers: an inner plastic layer, an intermediate paperboard layer, and an external packaging layer, wherein the outer layer accounts for a substantial portion of the structural strength of the package;

a package that includes a channel between an open end of a package and a closed end, to equalize pressure and facilitate removal of dough from the open end;

a package that include a flexible endcap that can deform to facilitate removal of the endcap from the package;

a package that includes an endcap comprising a pressure reservoir that can be actuated to increase pressure within the package to break a seal and open the package.

1-48. (canceled)

49. A packaged dough product comprising dough within a package, the package comprising
a container having a volume, container sides, and container ends, and
a plastic shrinkwrap outer layer.

50. A packaged dough product as recited at claim 49 wherein the shrinkwrap at least partially covers the container sides.

51. A packaged dough product as recited at claim 49 wherein the shrinkwrap at least partially covers the container sides and container ends.

52. A packaged dough product as recited at claim 49 wherein the package is of a fixed volume.

53. A packaged dough product as recited at claim 49 wherein the dough is proofed or partially proofed within the package.

54. A packaged dough product as recited at claim 53 wherein the package contains less than 3 percent headspace.

55. A packaged dough product as recited at claim 53 wherein the package has an internal pressure of 15 pounds per square inch (gauge) or more.

56. A packaged dough product as recited at claim 49 wherein the package is of a fixed volume.

57. A packaged dough product of claim 49 wherein the dough is a chemically leavenable dough that is proofed or partially proofed within the package.

58. A packaged dough product as recited at claim 49 wherein
the dough is a chemically leavenable dough that is proofed or partially proofed within the package,
the package contains less than 3 percent headspace, and
the package has an internal pressure of 15 pounds per square inch (gauge) or more.

59. A method of packaging dough, the method comprising
providing dough,
placing the dough in a package comprising
a container having a volume, container sides, and container ends, and
a plastic shrinkwrap outer layer, and
allowing the dough to proof or partially proof within the package.

60. A method as recited at claim 59 wherein the shrinkwrap at least partially covers the container sides.

61. A method as recited at claim 59 wherein the shrinkwrap covers at least partially the container sides and container ends.

62. A method as recited at claim 59 wherein the dough is unproofed when placed in the package.

63. A method as recited at claim 59 wherein the package containing the proofed or partially proofed dough contains less than 3 percent headspace.

64. A method as recited at claim 59 wherein the package containing the proofed or partially proofed dough has an internal pressure of 15 pounds per square inch (gauge) or more.

65. A method as recited at claim 59 wherein the package is of a fixed volume.

66. A method of claim 59 comprising heating the shrinkwrap.

67. A method of claim 59 comprising storing the dough at refrigerated temperature.

68. A method of claim 59 wherein the dough is a chemically leavenable dough.
